(19) United States
(12) Patent Application Publication
(10) Pub. No.: US 2016/0210334 A1
(43) Pub. Date: Jul. 21, 2016

(54) DEEP LINKING AND STATE PRESERVATION VIA A URL

(71) Applicant: salesforce.com, inc., San Francisco, CA (US)

(72) Inventors: Didier Prophete, San Francisco, CA (US); Vijayasarathy Chakravarthy, Mountain View, CA (US); David Tsang, San Francisco, CA (US)

(73) Assignee: SALESFORCE.COM, INC., San Francisco, CA (US)

(21) Appl. No.: 14/598,157

(22) Filed: Jan. 15, 2015

(51) Int. Cl. G06F 17/30; G06F 17/22; G06F 3/0484

(52) U.S. Cl. CPC G06F 17/30554; G06F 17/30887; G06F 3/04847; G06F 17/2235

(57) ABSTRACT

The technology disclosed relates to a platform for ultra-fast, ad-hoc data exploration and faceted navigation on integrated, heterogeneous data sets. The disclosed apparatus and methods for deep linking and state preservation via a URL make it possible to share live data as rendered on a live dashboard, without saving a new state on a server every time data and dashboard elements are updated.

### RELATED APPLICATIONS

This application is related to U.S. patent application Ser. No. 14/512,258, entitled, “Visual Data Analysis with Animated Informational Morphing Replay,” filed on Oct. 9, 2014 (Attorney Docket No. SALE 1100-1/1455US). The non-provisional application is hereby incorporated by reference for all purposes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed inventions.

Businesses need the ability to query and to view query results in real time, for large data sets being analyzed, in order to make informed business decisions. Developers of a platform for ultra-fast, ad-hoc data exploration and faceted navigation on integrated heterogeneous data sets need the ability to communicate information that enables team members to replicate layouts with specific data selections. The disclosed technology relates to a system and method for deep linking of layouts and data selections via an encoded URL.

Existing systems do not typically provide the ability to replicate a snapshot of “live” business analytics for large volumes of data. The disclosed apparatus and methods for deep linking and state preservation via a URL make it possible to share live data as rendered on a live dashboard, without saving a new state on a server every time data and dashboard elements are updated. Other aspects and advantages of the technology disclosed can be seen on review of the drawings, the detailed description and the claims, which follow.

### BRIEF DESCRIPTION OF THE DRAWINGS

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 illustrates an example business information and analytics architecture environment.

FIG. 2 shows a block diagram for a live dashboard implementation.

FIG. 3 shows a block diagram for a URL engine.

FIG. 4A through FIG. 4H shows an example schema for an enablement of a router that encodes and decodes encapsulated URLs.

FIG. 5 shows an example explore lens—“Sum of Amount by Forecast Category by Stage Name”.

FIG. 6 shows an example pie chart visualization of opportunity by fiscal year.

FIG. 7A through FIG. 7D show an animation progression for pie chart visualization of count of opportunities by region and fiscal year, morphing from the pie chart visualization of opportunity by fiscal year shown in FIG. 6 to a visualization option of a pie chart for each of three regions.

FIG. 8A shows an example dashboard with four display panels.

FIG. 8B shows an example dashboard with five display panels.

FIG. 8C shows an example dashboard with a specific region selected on one of the five display panels.

FIG. 9 shows an overview of the system flow for implementing deep linking and state preservation via a URL.

FIG. 10 illustrates a flowchart of one implementation of deep linking and state preservation via a URL.

FIG. 11 is a block diagram of an example computer system capable of deep linking and state preservation via a URL.

### DETAILED DESCRIPTION

### Introduction

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Insight data analysis supports data exploration, dashboard building, and declarative representation of data visualizations. During exploration and replayed exploration, changes in data filtering, grouping and presentation format are animated, showing how a change redistributes data values. Singularly and in combination, these features can contribute to successful data analysis and presentation.

During single panel data exploration and replay, new data visualizations are animated as they are designed. Drilling down on a data segment, for instance, causes the original data segment to subdivide according to the selected regrouping and visually progress through animated subdivision growth and rearrangement into a more granular data visualization. This helps the analyst understand the data, and subsequently, explain important data segments to colleagues who are interested in the process as well as the numbers.

Analysts can assemble dashboards of three or more panels that provide alternative visualizations of linked data. As an analyst creates a new panel, the system immediately applies the declared queries, widgets and bindings to the EdgeMart(s) involved to generate a data visualization. Notional or generic representations of pie and bar charts are replaced when applying this technology by live data visualizations, without requiring a user to switch from authoring/editing mode into an execution or user mode. (In this disclosure, “pie” and “donut” are used interchangeably to refer to a circular chart with wedges or segments. We recognize that many readers would call the charts in the figures donuts instead of pies.)

An assembled dashboard can be compactly represented by declarative data objects that fully describe panels by their properties. A widget that implements a panel is capable of translating the declarative data object into a data visualization. A selected widget, such as a pie chart widget, has a handful of properties that control how the widget binds to a query and displays data.

Exploration, both original and replay, benefits from animated visualization. Consider drill down and regrouping as a first example. Consider regional win rates on sales proposals worldwide. If Asia Pacific has the best success, an analyst can drill down into the Asia Pacific data several different ways to see what drives success. The analyst looks at a pie chart, for instance, and selects the Asia Pacific segment, choosing to group the data by industry type, with a bar chart visualization. The system responds by subdividing the Asia Pacific arc by industry type and animating the projection of sub-arcs into the bars of a bar chart. The sub-arcs lengthen, straighten and reposition during the animation. The analyst can see in the animation how the industry type bar chart visualization is derived from the regional data. The animation speed can be delivered more slowly or quickly, as suits the circumstances.

In a second example that extends the first, a trio of automotive supply-related bars on the chart show particularly successful results, so the analyst wants to find someone with whom to talk. The analyst selects the automotive supplier bar, grouping by sales representative, and chooses a stacked bar chart, accumulating sales in related industry segments. To do this, the analyst lassos, rubber bands or control-selects the three industry segments. Pull down menus are used to select grouping and visualization types. As soon as selections are complete, derivation of the regrouped visualization is animated. Each of the three bars is subdivided by sales representative. Parts of the bars extend and move to positions in a stacked bar chart. Animation of the segment to bar chart derivations can be staggered, so that the base of the stacked bar is constructed first, then subsequent layers. From the resulting visualization, two names stick out and the analyst knows who to contact. On replay, the analyst can reuse the queries that led to the contacts and retain or change the visualization types. This progression can produce a dashboard.

The regional pie chart, industry type bar chart, and sales representative stacked bar chart can be combined as three linked panels in a dashboard. Immediate data presentation, without shifting out of a develop-edit mode, enhances the development process. Suppose that the analyst first places the regional pie chart onto a fresh dashboard and selects the Asia Pacific segment. When the analyst creates a linked-industry type bar chart, the selection of the Asia Pacific segment can be specified as the data context by applying a facet property to the linked graphs. The specialized development environment provided by this technology immediately populates the linked-industry-type bar chart with live data from the same analytic data store that provides the pie chart with its data (or from a second data store joined with the first).

If the analyst-developer changes the segment selection in the pie chart to Europe, the industry-type bar chart updates without user action, without the user needing to shift from a develop or edit mode into a display mode. When the analyst creates a third panel with a sales representative stacked bar chart, segments selected in the other dashboard panels can be specified as the source of the data and applied to filter data grouped and illustrated in the new sales representative panel. The analyst benefits from seeing that the story being told is well represented in graphs of actual data, immediately upon adding the new graph panel to the dashboard. Mistakes in panel configuration and size issues with visualization are immediately apparent.

The system generates declarative data objects to represent the visualizations, both for replay of data exploration and for dashboards. Dashboards and exploration sequences can be recreated from declarative objects that represent the queries, visualizations, groupings and bindings explored by an analyst-author. Declarative objects specify properties to be applied and values of the properties. A single panel or a dashboard of panels is represented by a set of declarative objects. Declaration of these objects allows the runtime to create a limited but powerful set of data visualizations during exploration, creation, replay and user dashboard viewing. The vocabulary for declarative data objects is manageable because the declarative objects are special purpose with options capable of specifying queries, bindings and facets that the provided widgets understand and can consume to produce specific data visualizations. Properties of declarative objects can be specified using key-value pairs, as illustrated in the text that follows.

Development teams, working to customize visualizations containing big data, find it useful to communicate “snapshots” that include exact dashboard layouts with specific “live” data. State information is encapsulated in a URL and the URL is shared with members of the development team or quality assurance team, for review and feedback of the visualization. This general tool for deep linking and state preservation via a URL provides a powerful mechanism for communication, subject to security considerations. Team members, working behind a company's firewall, can send encoded URLs that replicate design and data selection modifications, and examples of errors identified during debug and testing of dashboard layouts. The receiving team member obtains the state information extracted from the URL, thereby viewing the latest bug or design change—avoiding the need to create, save and later delete a new version for every distinct lens or dashboard viewed. In some environments, the same approach could be used to deliver visualizations to end users and even to end users outside the company's firewall. For users outside the company's firewall, secure encryption might be desired, as encapsulated state information can include company proprietary information.

Examples of systems, apparatus, and methods according to the disclosed implementations are described in a “sales opportunity” context. The examples of sales contacts such as leads, prospects and accounts are used solely to add context and aid in the understanding of the disclosed implementations. In other instances, data with numerous elements may include airline flight arrival and departure times, insurance claims, customer service call routing, etc. or any data that would have a significant number of features. Other applications are possible, so the following examples should not be taken as definitive or limiting either in scope, context or setting. It will thus be apparent to one skilled in the art that implementations may be practiced in or outside the “sales opportunity” context.

### Architecture Environment

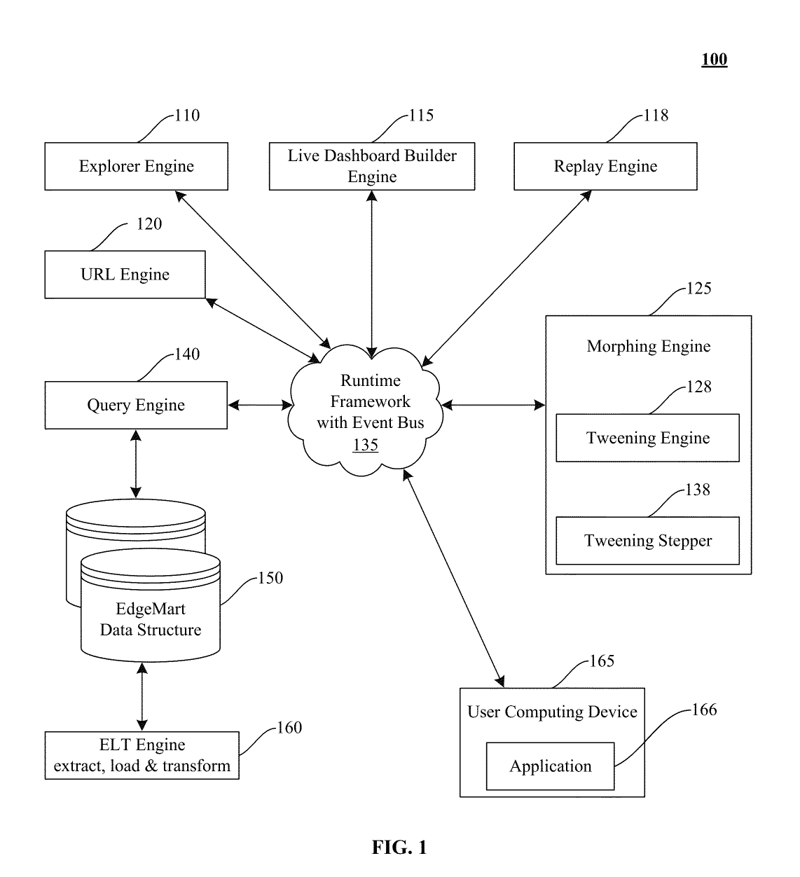

FIG. 1 shows an example analytics architecture environment in which a runtime framework with event bus 135 manages the flow of requests and responses between an Explorer engine 110, a query engine 140, and a live dashboard engine 115. Data acquired (extracted) from large data repositories is used to create “raw” EdgeMart data structures 150—read-only data structures for analytics—that can be augmented, transformed, flattened, etc. before being published as customer-visible EdgeMarts for business entities. A query engine 140 uses optimized data structures and algorithms to operate on these highly-compressed EdgeMarts 150, delivering exploration views of this data. Accordingly, an opportunity arises to analyze large data sets quickly and effectively.

Visualization queries are implemented using a declarative language to encode query steps, widgets and bindings to capture and display query results in the formats selected by a user. An Explorer engine 110 displays real-time query results. When activated by an analyst-developer, Explorer engine 110 runs EQL queries against the data and includes the data in lenses. A lens describes a data visualization: a query plus a chart option for rendering the query. The EQL language is a real-time query language that uses data flow as a means of aligning results. It enables ad hoc analysis of data stored in EdgeMarts. A user can select filters to change query parameters and can choose different display options, such as a bar chart, pie chart or scatter plot—triggering a real-time change to the display panel—based on a live data query using the updated filter options. An EQL script consists of a sequence of statements that are made up of keywords (such as filter, group, and order), identifiers, literals, or special characters. EQL is declarative: you describe what you want to get from your query. Then, the query engine will decide how to efficiently serve it.

A URL engine 120 encapsulates complete state information in a URL so that visualizations of real-time query results can be transmitted. A runtime framework with an event bus 135 handles communication between a user application 166, a query engine 140, and an Explorer engine 110, which generates lenses that can be viewed via a morphing engine 125. A disclosed live dashboard builder engine 115 designs dashboards, displaying multiple lenses developed using the Explorer engine 110 as real-time data query results. That is, an analyst can arrange display panels for multiple sets of query results from the Explorer engine 110 on a single dashboard. When a change to a global filter affects any display panel on the dashboard, the remaining display panels on the dashboard get updated to reflect the change. Accurate live query results are produced and displayed across all display panels on the dashboard.

The Explorer engine 110 provides an interface for users to choose filtering, grouping and visual organization options; and displays results of a live query requested by a user of the application 166 running on a user computing device 165. The query engine 140 executes queries on read only pre-packaged data sets—the EdgeMart data structures 150. The Explorer engine 110 produces the visualization lens using the filter controls specified by the user and the query results served by the query engine 140.

Explorer engine 110, query engine 140, live dashboard builder engine 115 and URL engine 120 can be of varying types including a workstation, server, computing cluster, blade server, server farm, or any other data processing system or computing device. In some implementations, Explorer engine 110 can be communicably coupled to a user computing device 165 via different network connections, such as the Internet. In some implementations, query engine 140 can be communicably coupled to a user computing device 165 via different network connections, such as a direct network link. In some implementations, live dashboard builder engine 115 can be communicably coupled to user computing device 165 via different network connections, such as the Internet or a direct network link.

The runtime framework with event bus 135 provides real time panel display updates to the live dashboard engine 115, in response to query results served by the query engine 140 in response to requests entered by application users 166. The runtime framework with event bus 135 sets up the connections between the different steps of the workflow. When new nodes get removed or added to the dashboard, connections are recomputed dynamically.

The morphing engine 125 receives a request from the event bus 135, and responds with a first chart or graph to be displayed on the live dashboard 115. Segments of a first chart or graph are filter controls that trigger generation of a second query upon selection by a user. Subsequent query requests trigger controls that allow filtering, regrouping, and selection of a second chart or graph of a different visual organization than the first chart or graph.

The morphing engine 125 includes tweening engine 128 and tweening stepper 138 that work together to generate pixel-level instructions—intermediate frames between two images that give the appearance that the first image evolves smoothly into the second image. That is, a shape can be described by a radius and an angle. The tweening engine 128 calculates the locations for the pixels and the tweening stepper 138 delivers an animation projection sequence for morphing a display panel from a first visualization lens to a second visualization option. The projections between the start and destination frames create the illusion of motion that gets displayed on the dashboard when a user updates data choices.

Runtime framework with event bus 135 can be of varying types including a workstation, server, computing cluster, blade server, server farm, or any other data processing system or computing device; and can be any network or combination of networks of devices that communicate with one another. For example, runtime framework with event bus 135 can be implemented using one or any combination of a LAN (local area network), WAN (wide area network), telephone network (Public Switched Telephone Network (PSTN), Session Initiation Protocol (SIP), 3G, 4G LTE), wireless network, point-to-point network, star network, token ring network, hub network, WiMAX, Wi-Fi, peer-to-peer connections like Bluetooth, Near Field Communication (NFC), Z-Wave, ZigBee, or other appropriate configuration of data networks, including the Internet. In other implementations, other networks can be used such as an intranet, an extranet, a virtual private network (VPN), a non-TCP/IP based network, any LAN or WAN or the like.

The ELT engine 160 uses an extract, load, transform (ELT) process to manipulate data served by backend system servers to populate the EdgeMart data structures 150. EdgeMart data structures 150 can be implemented using a general-purpose distributed memory caching system. In some implementations, data structures can store information from one or more tenants into tables of a common database image to form an on-demand database service (ODDS), which can be implemented in many ways, such as a multi-tenant database system (MTDS). A database image can include one or more database objects. In other implementations, the databases can be relational database management systems (RDBMSs), object oriented database management systems (OODBMSs), distributed file systems (DFS), no-schema database, or any other data storing systems or computing devices.

Various types of on-demand transactional data management systems can be integrated with analytic data stores to provide to data analysts ad hoc access to query the transaction data management systems. This can facilitate rapid building of analytic applications that use numerical values, metrics and measurements to drive business intelligence from transactional data stored in the transaction data management systems and support organizational decision making Transaction data refers to data objects that support operations of an organization and are included in application systems that automate key business processes in different areas such as sales, service, banking, order management, manufacturing, aviation, purchasing, billing, etc. Some examples of transaction data include enterprise data (e.g. order-entry, supply-chain, shipping, invoices), sales data (e.g. accounts, leads, opportunities), aviation data (carriers, bookings, revenue), and the like.

In some implementations, user computing device 165 can be a personal computer, a laptop computer, tablet computer, smartphone or other mobile computing device, personal digital assistant (PDA), digital image capture devices, and the like. Application 166 can take one of a number of forms, running in a browser or as an application, including user interfaces, dashboard interfaces, engagement consoles, and other interfaces, such as mobile interfaces, tablet interfaces, summary interfaces, or wearable interfaces. In some implementations, it can be hosted on a web-based or cloud-based server in an on premise environment. In one implementation, application 166 can be accessed from a browser running on a computing device. The browser can be Chrome, Internet Explorer, Firefox, Safari, Opera, and the like. In other implementations, application 166 can run as an engagement console on a computer desktop application.

In other implementations, environment 100 may not have the same elements or components as those listed above and/or may have other/different elements or components instead of, or in addition to, those listed above, such as a web server and template database. The different elements or components can be combined into single software modules and multiple software modules can run on the same hardware.

### Morphine and Replay

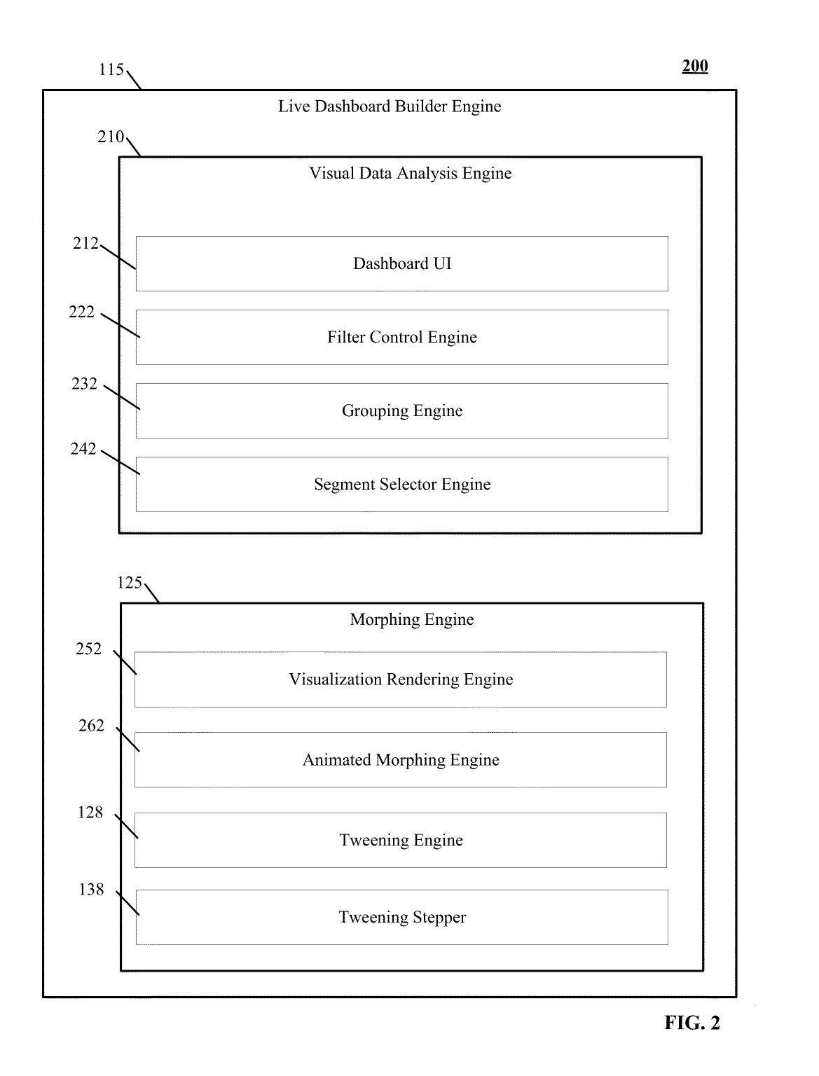

FIG. 2 shows a block diagram for the live dashboard builder 115, which includes, but is not limited to, a visual data analysis engine 210 and a morphing engine 250. A visual data analysis engine 210 conveys analysis results via a dashboard UI 212, for display on the dashboard. A grouping engine 232 monitors which data fields are to be displayed in a specific visual organization, such as a pie chart or bar chart. A segment selector engine 242 processes filter controls for the charts, graphs and plots. That is, the segment selector engine 242 signals requests for changes to filtering, grouping and variations in visual organization—such as a transformation from a bar chart to a pie chart—to the filter control engine 222. Query requests use the signal received from the segment selector engine 242.

The morphing engine 250 delivers an animated sequence that transforms a display panel from a first grouping to a second appearance, or visual organization, based on results of a second query. A visualization rendering engine 252 combines information from both the visual data analysis engine 210 and the filter control engine 222, and renders dashboard updates to the dashboard UI 212. An animated morphing engine 262 morphs a first chart or graph from a first appearance in a first sort order through an animation sequence to a second sort order that corresponds to the sorting control signal.

Replay engine 118 uses the workflow engine to capture all the events being fired and their timestamp. The replay function later re-fires the same events in the proper order—replaying the events recorded via the workflow engine.

### Deep Linking and State Preservation

The state of a lens, dashboard or application can be stored on a server with an associated ID that serves as proxy for an object string that represents the visualization. Recall that a lens is a single visualization, a dashboard includes a set of visualizations and selectors, and an application is a group of lenses and dashboards. The state of any of these visualization objects, sometimes referred to as assets, can be encapsulated in a URL, and the URL can be encoded or lightly encrypted and shared.

Encoding of a lens or dashboard can capture its entire layout. For situations in which the layout has already been saved, current selections can be encoded in a JSON string and appended to a URL that encodes the layout or references an encoding of the layout. At the server, reverse encoding can be performed to retrieve the state and selections. When the layout has not yet been saved, the state information can be identified, compressed and encoded for the entire structure of a shared lens or dashboard. A uniform resource identifier (URI) is a string of characters used to identify a name of a resource, thus enabling interaction with representations of the resource over a network, using specific protocols. Schemes specifying a concrete syntax and associated protocols define each URI. The most common form of URI is the uniform resource locator (URL), frequently referred to informally as a web address. The URL engine 120 encodes and decodes a URI component as part of the deep linking and state preservation process described below.

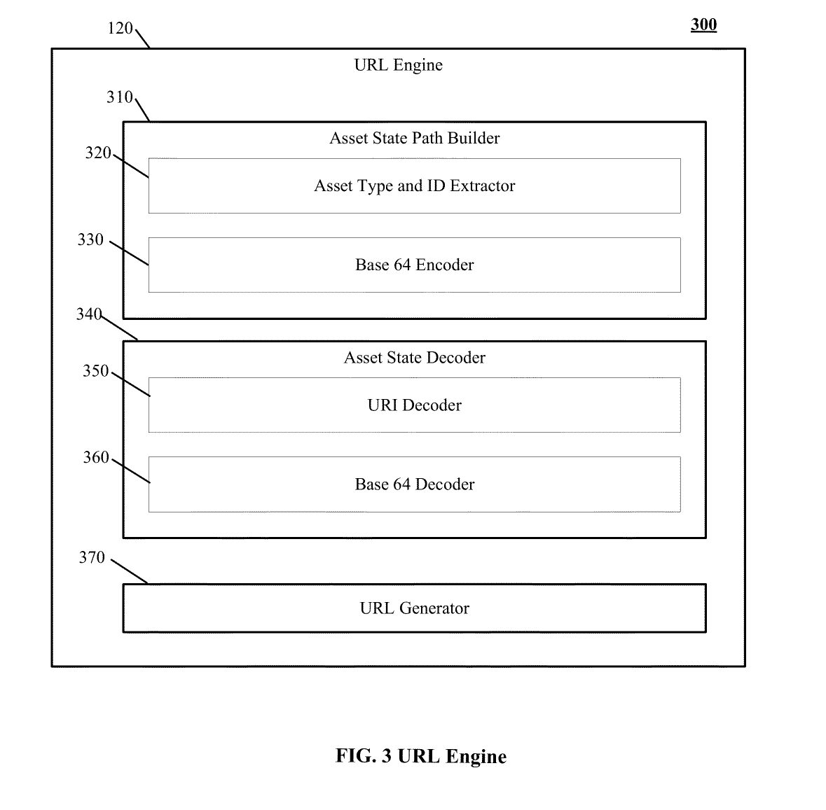

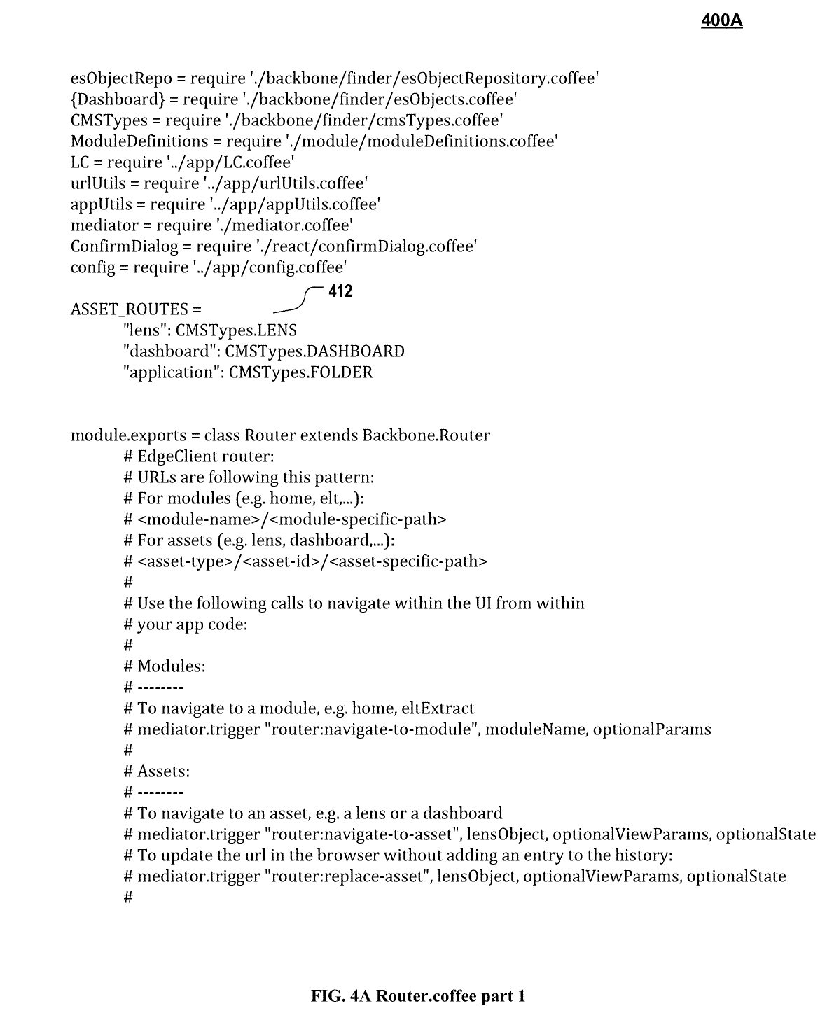

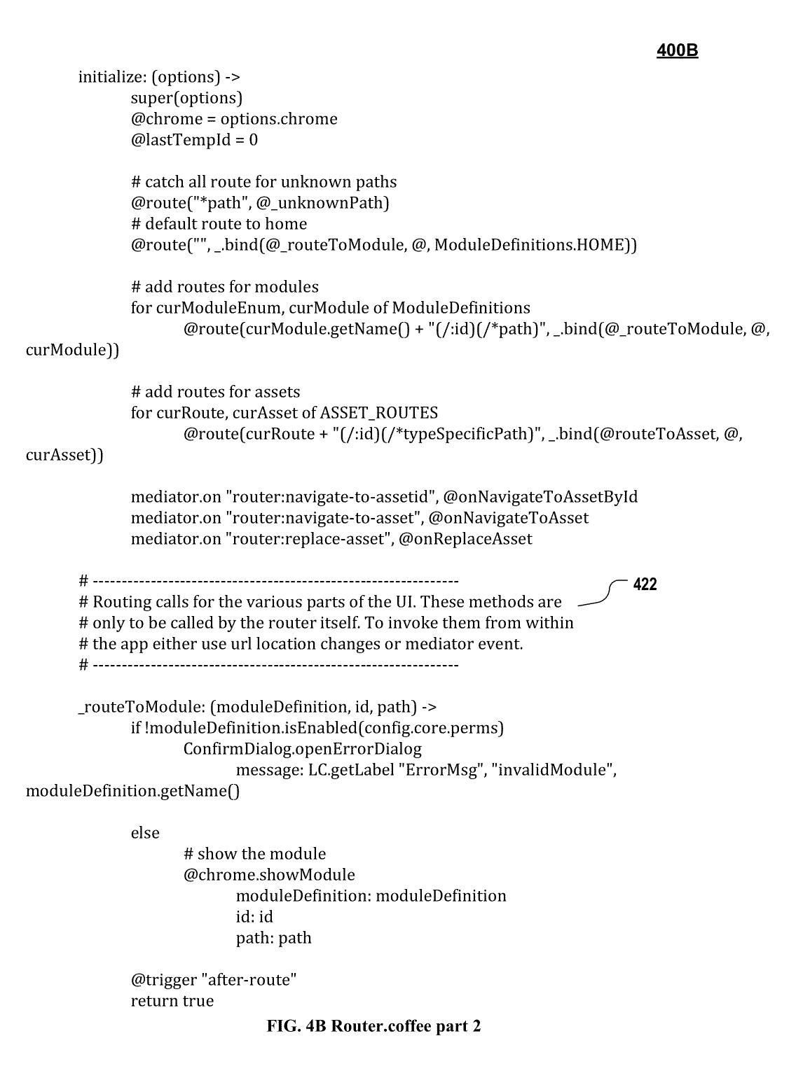

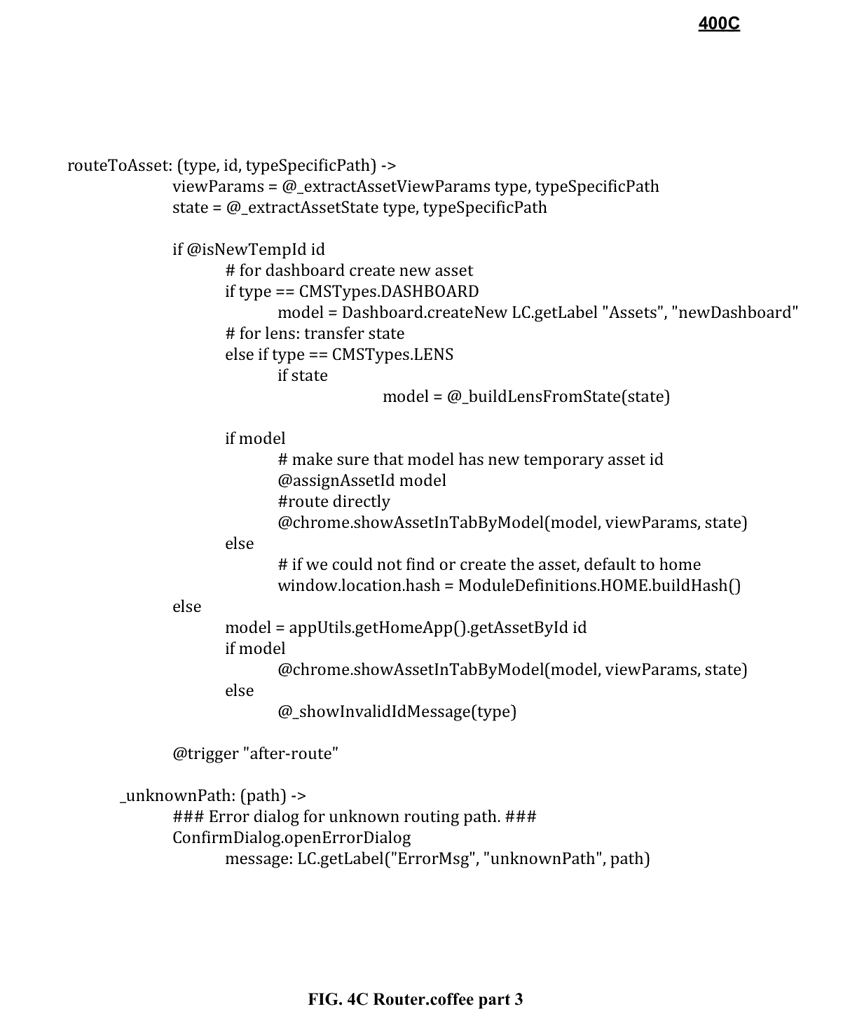

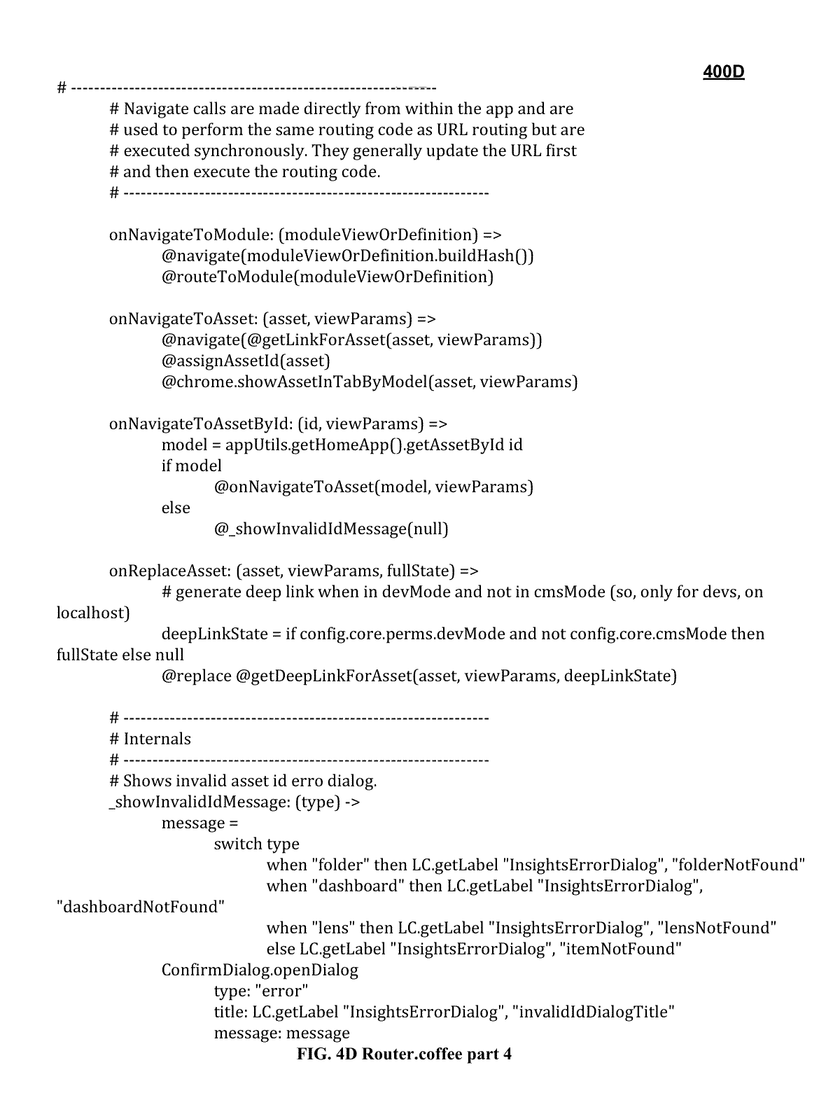

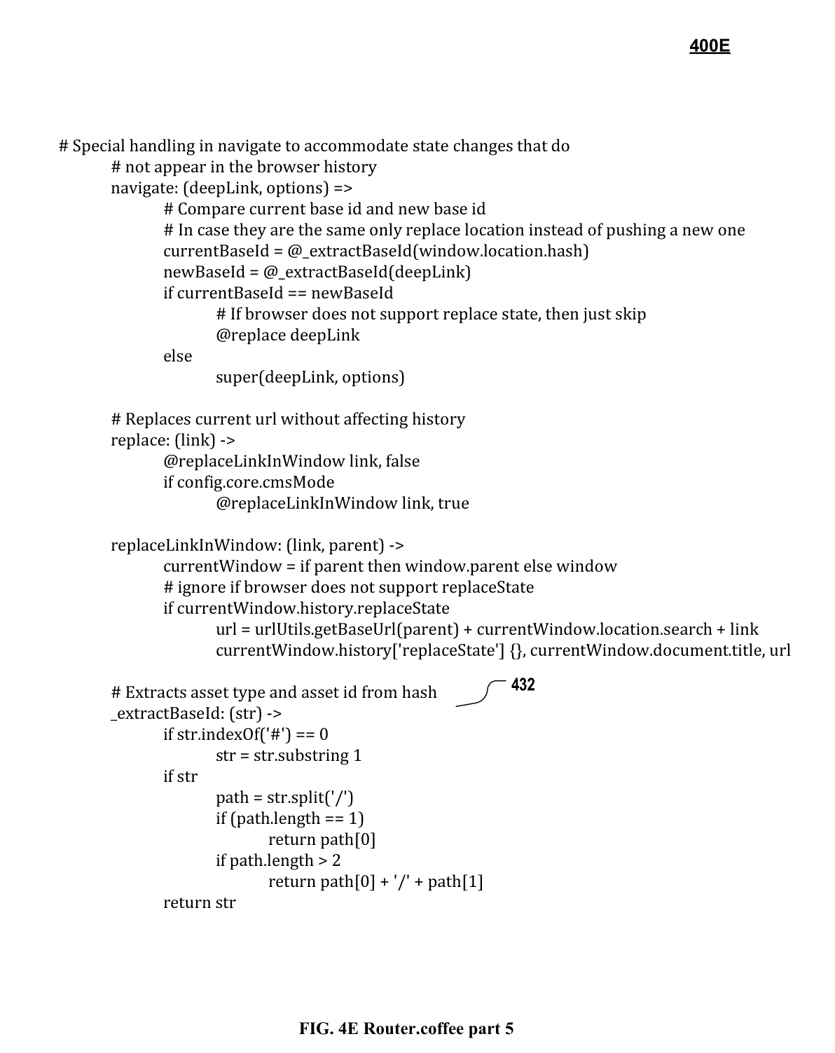

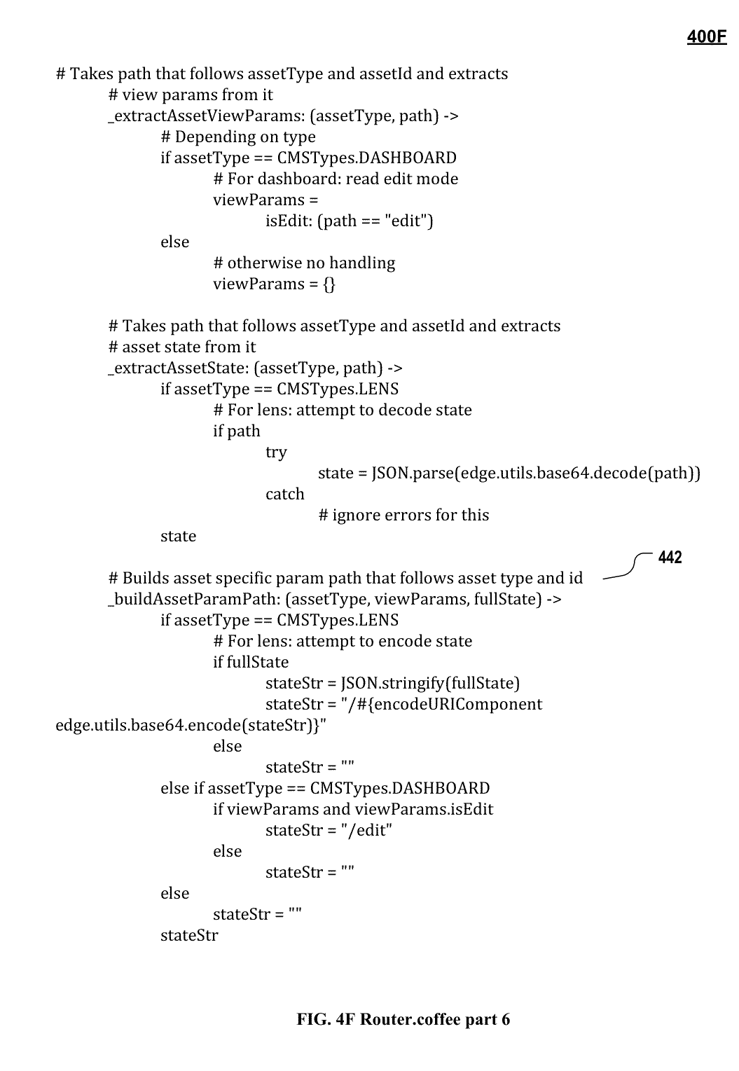

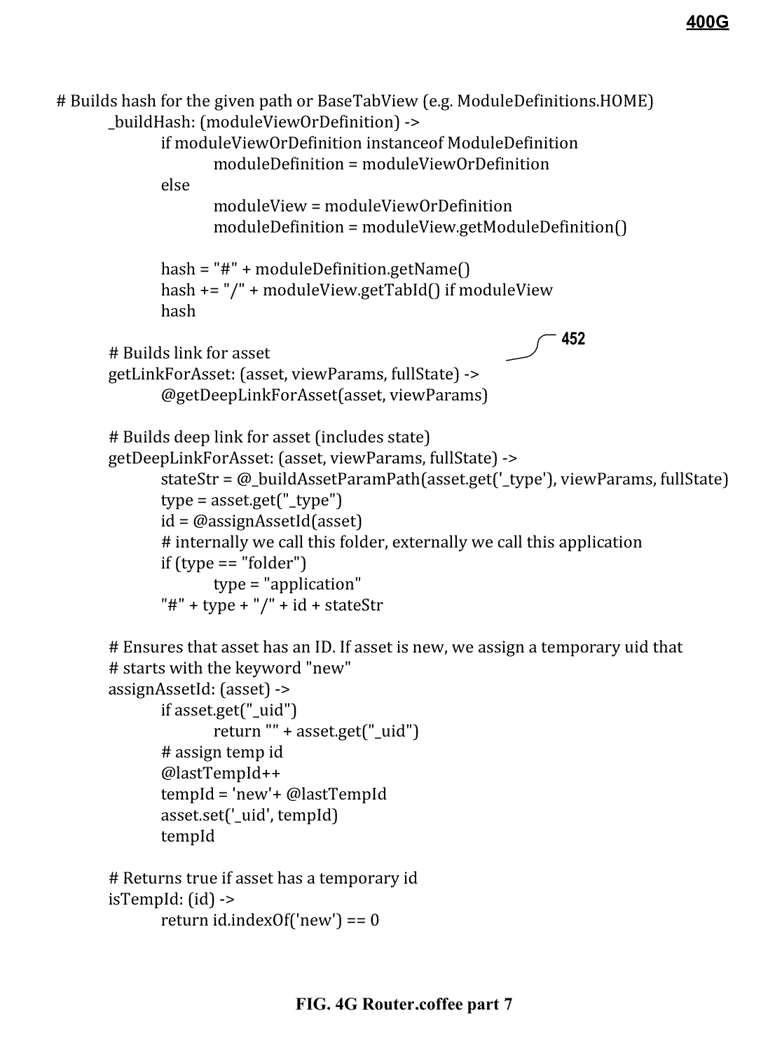

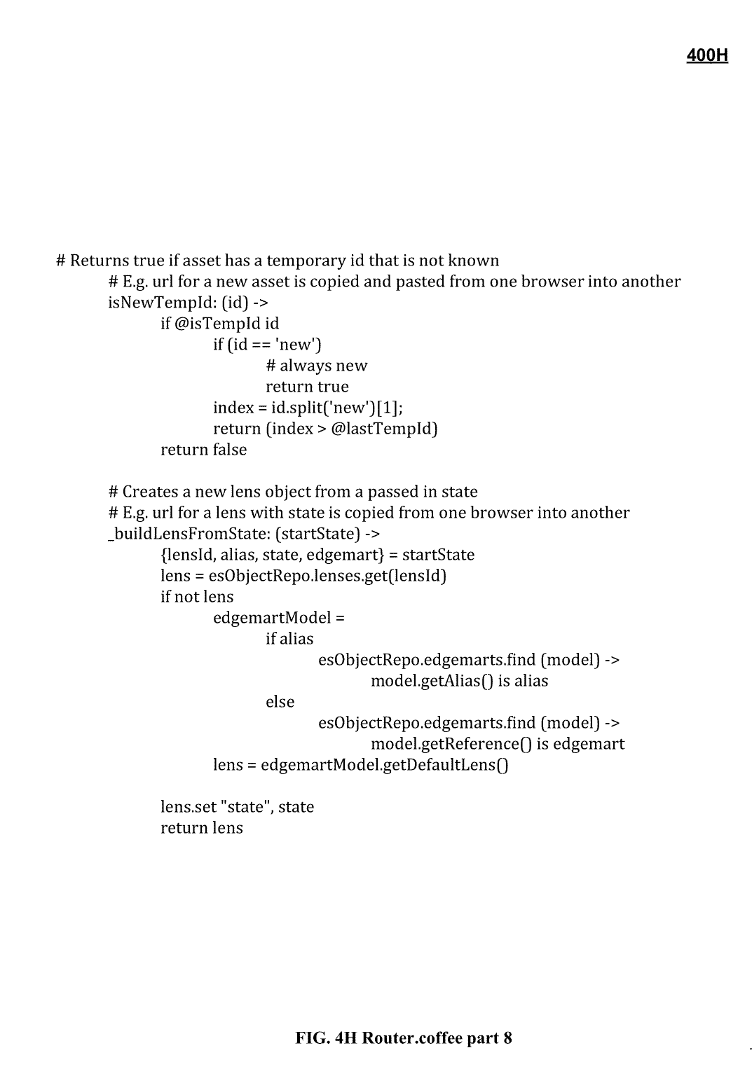

FIG. 3 shows a block diagram of the URL engine 120 that includes an asset state path builder 310, an asset state decoder 340, and a URL generator 370. Two examples of assets are a lens and a dashboard. Dashboard and lens visualizations can be encoded with a complete layout, or with selections within a layout. In one implementation, JSON code defines assets and describes how to build an asset-specific parameter path that matches the asset type and ID. An example implementation is shown in FIG. 4A-4H in router.coffee. FIG. 4A shows asset routes 412 for a lens, dashboard and application. FIG. 4B shows routing calls for various parts of the UI 422.

The following code snippet from router.coffee follows an asset-specific parameter path and decodes state information for a visualization. Similar code can be applied to decoding selection information. An asset type and ID extractor 320 identifies what type of asset is being encapsulated and an asset ID for the asset. Asset state decoder 340 can be implemented as shown in the following sample extractor JSON code snippet 432 that follows an asset-specific parameter path that matches the asset type and ID, and decodes the URI component using base 64 decoder 360.

```
# Extracts asset type and asset id from hash
    _extractBaseId: (str) ->
        if str.indexOf(‘#’) == 0
            str = str.substring 1
        if str
          path = str.split(‘/’)
          if (path.length == 1)
                return path[0]
            if path.length > 2
                return path[0] + ‘/’ + path[1]
        return str
# Takes path that follows assetType and assetId and extracts view params
from it
_extractAssetViewParams: (assetType, path) ->
# Depending on type
if assetType == CMSTypes.DASHBOARD
# For dashboard: read edit mode
viewParams =
isEdit: (path == “edit”)
        else
            # otherwise no handling
            viewParams = { }
# Takes path that follows assetType and assetId and extracts asset state
from it
_extractAssetState: (assetType, path) ->
  if assetType == CMSTypes.LENS
    # For lens: attempt to decode state
  if path
    try
      state = JSON.parse(edge.utils.base64.decode(path))
  catch
    # ignore errors for this state
```

FIG. 4F shows a JSON code snippet 442, reproduced in part below, that implements building an asset-specific parameter path that follows the asset type and ID, encoding a URI component using a base64 utility.

# Builds asset specific param path that follows asset type and id
_buildAssetParamPath: (assetType, viewParams, fullState) −>

if assetType == CMSTypes.LENS

# For lens: attempt to encode state
if fullState

stateStr = JSON.stringify(fullState)
stateStr = “/#{encodeURIComponent

edge.utils.base64.encode(stateStr)}”

else

stateStr = “”

else if assetType == CMSTypes.DASHBOARD

if viewParams and viewParams.isEdit

stateStr = “/edit”

else

stateStr = “”

else

stateStr = “”

stateStr

FIG. 4G shows a JSON code snippet 452, reproduced in part below, that implements the build of the deep link for an asset:

```
# Builds link for asset
      getLinkForAsset: (asset, viewParams, fullState) ->
            @getDeepLinkForAsset(asset, viewParams)
# Builds deep link for asset (includes state)
getDeepLinkForAsset: (asset, viewParams, fullState) ->
      stateStr = @_buildAssetParamPath(asset.get(‘_type’),
      viewParams, fullState)
            type = asset.get(“_type”)
            id = @assignAssetId(asset)
            # internally we call this folder, externally we call this
            application
            if (type == “folder”)
                  type = “application”
            “#” + type + “/” + id + stateStr
```

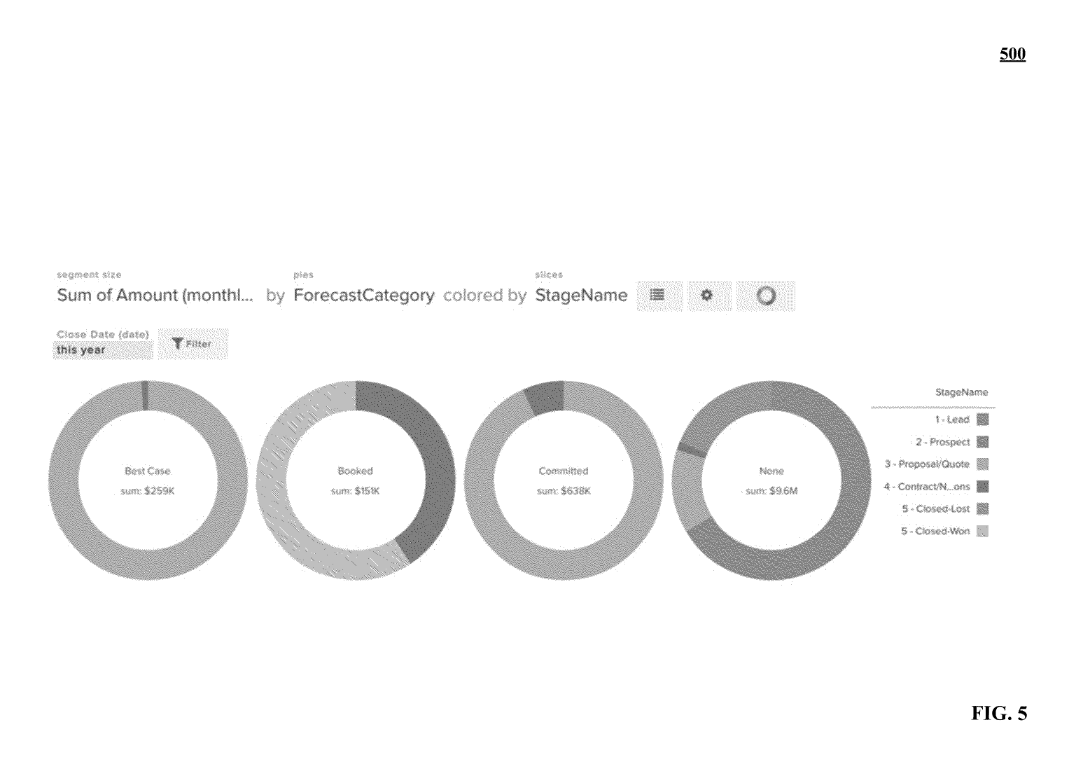

FIG. 5 shows an example explore lens—“Sum of Amount by Forecast Category by Stage Name”. The unminified state for this lens can be represented as follows:
{“query”: {“measures”:[[“sum”,“Amount”]],“groups”:[“ForecastCategory”,“StageName”], “filters”:[[“Close Date”,[[[“year”,0],[“year”,0]]]]]},“type”:“pie”

The encapsulated URL for the example lens shown in FIG. 5 is generated using this implementation method. The resultant URL when the lens state is minified—that is, after removing all unnecessary characters without changing its functionality—is:
http://localhost/˜didier.prophete/WaveUI/Client/ui/explore.html#lens/Lens20/eyJzdGF0Z SI6eyJxdWVyeSI6eyRZWFzdXJlcyI6W1sic3VtIiwiQW1vdW50Il1dLCJncm91cHMiOl siRm9yZWNhc3RDYXRlZ29yeSIsIlN0YWdlTmFtZSJdLCJmaWx0ZXJzIjpbWyJDbG9 zZSBEYXRlIixbW1sieWVhciIsMF0sWyJ5ZWFyIiwwXV1dXV19LCJ0eXBlIjoicGllIn0 sImVkZ2VtYXJ0IjoiLi4vLi4vQ29tbW9uL3JlcG8vZWRnZW1hcnRzL09wcG9ydHVua XR5L09wcG9ydHVuaXR5RU0ifQ%3D%3D

The encapsulated URL can be transmitted from a one developer to another on a team, or to a reviewer or quality assurance tester, enabling the recipient to recreate the exact visualization with current “live” data, while avoiding the need to create, save and later delete a new version for every lens or dashboard viewed.

This encoding and encapsulation can be applied to any of the lens, dashboard or application examples that follow. Further examples can be found in U.S. patent application Ser. No. 14/512,258, entitled, “Visual Data Analysis with Animated Informational Morphing Replay,” filed on Oct. 9, 2014 (Attorney Docket No. SALE 1100-1/1455US), referred to above and incorporated by reference for all purposes. Much of what follows is copied from the incorporated application.

### Dashboard Object Implementation

Advanced dashboards are created by directly modifying the source files that define the dashboards. In one implementation, a dashboard JSON file defines the components that a dashboard includes and describes how the components are connected together. The following sample JSON file defines a dashboard that uses a number widget to display the count of rows in an EdgeMart. This JSON file defines one widget, called “number_1”.

{

“name_lc”: “simple example dashboard”,
“state”: {

“widgets”: {

“number_1”: {

“params”: {

“title”: ““,
“textColor”: “#000”,
“measureField”: “count”,
“fontSize”: 36,
“step”: “step_1”

},
“type”: “NumberWidget”,
“pos”: {

“w”: 300,
“y”: 40,
“h”: “auto”,
“x”: 40

}

}

},

This JSON file also defines one step, called “step_1.

```
“steps”: {
      “step_1”: {
            “isFacet”: true,
            “start”: null,
            “query”: {
                  “values”: [ ],
                  “order”: [ ],
                  “pigql”: null,
                  “dimensions”: [ ],
                  “measures”: [
                        [
                              “count”,
                              “*”
                        ]
                  ],
                  “aggregateFilters”: [ ],
                  “groups”: [ ],
                  “filters”: [ ],
                  “formula”: null
                  },
                  “extra”: {
                        “chartType”: “hbar”
                  },
                  “selectMode”: “single”,
                  “useGlobal”: true,
                  “em”: “0Fb400000004CH2CAM”,
                  “type”: “aggregate”,
                  “isGlobal”: false
            }
      },
      “cards”: { }
},
“_uid”: “0FK400000004CGOGA2”,
“_createdBy”: {
      “_type”: “user”,
      “profilePhotoUrl”: “https://myorg/profilephoto/005/T”,
      “name”: “Insights DashEditor”,
      “_uid”: “00540000000Hew7AAC”
},
“folder”: {
      “_type”: “folder”,
      “_uid”: “00540000000Hew7AAC”
},
“_container”: {
      “_container”: “0FK400000004CGOGA2”,
      “_type”: “container”
},
```

The “EdgeMarts” section of the JSON file lists the EdgeMarts that the dashboard uses.

“_type”: “dashboard”,
“EdgeMarts”: {

“emName”: {

“_type”: “EdgeMart”,
“_uid”: “0Fb400000004CH2CAM”

}

},
“_createdDateTime”: 1406060540,
“_permissions”: {

“modify”: true,
“view”: true

},
“description”: ““,
“_url”: “/insights/internal_api/v1.0/esObject/lens/0FK400000004CGOGA2/json”,
“name”: “Simple example dashboard”,
“_lastAccessed”: 1406060541,
“_files”: { }

}

In the code above, the steps section includes all of the queries clipped from the Explorer. In one implementation, each step has a name that is used to link it to a widget that is defined elsewhere in the JSON file. The steps section of a dashboard JSON file can have a plurality of properties. In one implementation, an “em” property refers to the alias of the EdgeMart that the step uses. In another implementation, an “extra” property specifies the extra information about the step. Also, an ‘isFacet” property indicates whether the step is connected to other steps used in the dashboard (true) or not (false). In some implementations, a global filter can filter all other steps in the dashboard that have their “useGlobal” property set to true, and that reference the same EdgeMart. Further, a “query” property refers to the query that the step uses. In some implementations, it can be in EQL or compact form. A “selectmode” property determines the selection interaction for charts and selectors. In one implementation, the different charts can be none, single and single_required. In another implementation, the selectors can be single, single_required or refreshed. In addition, a “start” property identifies the default start value or values for a step. This value can be used when a dashboard is initialized or refreshed, according to one implementation. Further yet, a “type” property designates a type of the step, including at least one of grain, aggregate, multi and static. A “useGlobal” property indicates whether the step uses the dashboard's global filter (true) or not (false).

Referring to the above code again, the code's widgets section defines all the widgets that appear in the dashboard. In one implementation, each widget in the dashboard is assigned a name in the code. The different properties of the widgets section of a dashboard JSON file include at least one of “params,” “pos” and “type.” In one implementation, “params” property identifies the different widget parameters, which vary depending on the type of widget. Further, the step that a widget is attached to is defined by its step element. The “pos” property determines a position of the top left corner of the widget, which is specified by x and y. In addition, each widget's width is specified as w and height as h. In some implementations, widget measurements are made in pixels. Moreover, the “type” property specifies one of the other supported widget types such as NumberWidget, ChartWidget, ValuesTable, CompareTable, PillBox, ListSelector or TextWidget.

The code above also includes a query section of a dashboard JSON file. A “pigql” property of the query section refers to an EQL query. EQL language is a real-time query language that uses data flow as a means of aligning results and allows for ad hoc analysis of data stored in EdgeMarts. Also, a “measures” property specifies quantities that can be measured, for example, sum, amount, unit sales of a product or cost of inventory items. In one implementation, the measures can be specified as “measures”: [[“count”, “*”]]. A “dimensions” property is an attribute, or a set of attributes, by which the measures are divided into sub-categories. In one implementation, the dimensions are specified as “dimensions”: [[“Department”, “*”]]. Moreover, a “values” property is used with a grain step type in a step for a raw data table widget. In one implementation, values lists all of the columns to include in a grain or raw data table. For example:

“step_grain”: {

“type”: “grain”,
values
“em”: “opp”,
“query”: {

“values”: [“Amount”, “Owner-Name”, “Name”, “Account-
Name”, “StageName”,

“ForecastCategory”, “Current Age”, “Time to Win”],
}

}

Further, a “filters” property applies filter conditions to the data. Following is an example of a filter condition to include only rows with destination “SFO”, “LAX”, “ORD”, or “DFW”—“filters”: [[“dest”, [“SFO”, “LAX”, “ORD”, “DFW”}]]. A “groups” property determines how dimensions are grouped. For example, “groups”: [“carrier”]. The following code shows one example of filtering an EdgeMart named “opportunity” based on 2011, 2012 and 2013 closing years:

```
step_global_filters:
    type: “aggregate”
    em: “opp”
    query:
        filters: [
            [“CloseDate_Year”, [“2013”, “2012”, “2011”]]
        ]
    isGlobal: true
```

In other implementations, other filter widgets can be defined such as representative filter (owner-name), year filter (closedate-year), amount filter (sum), product filter (product), region filter (region), account filter (account-name), stage name filter (closed-won), open opportunities filter (lead, prospect, proposal/quote, contract/negotiations), quarterly bookings filter (closedate-quarter), win loss filter (closed-won, closed-lost), owner by role filter (owner-userrole-name), quotas by roles filter (role, closed year), cogroup filter (owner by role, quotas by role), user role filter (owner, userrole, name) and quotas by userrole filter (closed year, role).

Further yet, an “order” property sets the sort order as “order”: [[−1, {“ascending”: false}]], according to one example. In this example, a −1 value indicates that the ordering is done for the first measure. To order the results in ascending order, the ascending is set to true, in one implementation. In another implementation, to order the results in descending order, the ascending is set to false. In yet another implementation, empty brackets are specifies, like this “order”: [ ], to avoid imposing a specific order. In addition, a “limit” property determines a number of results that are returned. In one example, the limit is set to return ten results by “limit”: 10. A “formula” property is used with a multi type step in a step for a compare table, according to one implementation. In some implementations, a multi type step can include more than one subquery and mathematical operators such as *, /, −, +, (, and) can be used to create a formula to reference other subqueries in the step.

In one implementation, a plurality of selector widgets can be used to stratify the data in the dashboard based on different categories. In one example, a group selector widget lets user indicate whether they want to group by account or product. When a user makes a selection, the dashboard is updated accordingly. In one implementation, the part of the query that controls the filtering is—q=filter q by ‘Account-Name’ in {{selection(step_Account_Owner_Name_2)}}. The step that is named step_Account_Owner_Name_2 is configured as a selection binding so as to pick up the current selection state. Because it is within the double braces, the value of that selection can be substituted and used in the query. The part of the query that controls the grouping is:
q=group q by {{single_quote(value(selection(step_StageName_3)))}};
q=for each q generate {{single_quote(value(selection(step_StageName_3)))}} as {{value(selection(step_StageName_3))}}, sum(Amount) as ‘sum_Amount’, count( ) as ‘count’”;

If a user selects Product category in the group selector widget, the actual query that is passed to the query engine includes:
q=group q by ‘Product’;
q=for each q generate ‘Product’ as “Product”, sum(Amount) as ‘sum_Amount’, count( ) as
‘count’;

In other implementations, other selector widgets can be defined such as representative selector (owner-name), year selector (closedate-year), amount selector (sum), product selector (product), region selector (region), account selector (account-name), stage name selector (closed-won), open opportunities selector (lead, prospect, proposal/quote, contract/negotiations), quarterly bookings selector (closedate-quarter), win loss selector (closed-won, closed-lost), owner by role selector (owner-userrole-name), quotas by roles selector (role, closed year), cogroup selector (owner by role, quotas by role), user role selector (owner, userrole, name) and quotas by userrole filter (closed year, role).

In one implementation, the different filters and selectors are represented as different widgets. In some implementations, this is achieved by—specifying a type of the widget such as list selector widget, range selector widget, chart selector widget, pillbox widget, values table widget, number widget and action button widget (explore); setting two-dimension (x, y) or three-dimension (x, y, z) positions and height (h) and width (w) of the widget; specifying if the widget is expandable (true) or not (false); setting a title of the widget (string); identifying the step that uses widget (this links the widget to the respective filter or selector included in the identified step); specifying a select mode of the widget (single, multi-select); and setting a measure of the widget (sum, account). In other implementations, the widget types are further stratified into various geometrical constructs like a vertical bar chart (vbar), a horizontal bar chart, a pie chart, a line chart, time and a scatter plot. The following code shows one example of defining a widget in a dashboard. In this example, a sales representative selector in a step named “step_all_salesreps” is linked to a sel_salesreps widget titled “salesrep selector” and shaped as a pie chart:

```
# sales representative selector
      step_all_salesreps:
            type: “aggregate”
            em: “opp”
            query:
                  groups: [“Owner-Name”]
                  measures: [ [“sum”, “Amount”] ]
                  order: [ [−1, ascending: false] ]
            extra:
                  chartType: “pie”
            isFacet: true
            useGlobal: true
widgets:
      sel_salesreps:
      type: “ChartWidget”
      pos:
            x: 310
            y: 70
            w: 470
            h: 380
      params:
            expanded: false
            title: “salesrep selector”
            step: “step_all_salesreps”
            ChartType = “pie”
            instant: true
            multiSelect: false
            measureField: “sum_Amount”
```

After the steps are defined, they are bound to the widgets using different types of bindings, such as selection binding, results binding and filter binding. When a user makes a selection in a dashboard, that selection values can be used to update other steps and widgets to make the dashboard interactive. Further, when a dashboard is build using the dashboard builder UI, all the dashboard components are faceted. In one implementation, the “isFaceted” property for each step enables bidirectional selection bindings between steps of the same EdgeMart. In some implementations, facet bindings are set up for all the steps marked with “isFaceted”=true as follows:

_initFacets: −>

# map: em url −> array of step names faceted for this em
facetStepsByEmMap = { }
# The faceted steps are grouped together by EdgeMart
# All the faceted steps for a given EdgeMart are faceted together
for name, step of @_stepsByName

delete step.query.facet_filters if step.query
if step.isFacet

type = step.type
@_throwError(LC.getLabel “ErrorMsg”, “invalidStepForFacet”,
type, name,
JSON.stringify(RuntimeEngine.VALID_FACET_TYPES)) unless
type in RuntimeEngine.VALID_FACET_TYPES
@_throwError(LC.getLabel “ErrorMsg”,
“invalidFacetedStaticStep”, name) if type is “static” and (not
step.dim or not step.em)
emUrl = @_getEmUrlForStep step
facetStepsByEmMap[emUrl] ?= [ ]
facetStepsByEmMap[emUrl].push name

for emUrl, facetSteps of facetStepsByEmMap

for mainStepName in facetSteps

mainStep = @_stepsByName[mainStepName]

In some implementations, a dashboard JSON file is directly modified to manually specify the relationships between the various steps to facilitate—selection bindings between steps of different EdgeMarts, unidirectional selection binding and selection binding for a static step. In some implementations, all parts of a step can include a selection binding to the results of a prior query. In an aggregate query, the fields that can be included in a selection binding include group, measure, filters, sort and limit.

In other implementations, the results binding is used to filter a step using the values resulting from another step across multiple EdgeMarts. In one example, results binding enables filtering of opportunities by top-selling products, as shown in the code below:

```
step_all_salesreps:
      type: “aggregate”
      em: “opp”
      query:
            groups: [“Owner-Name”]
            filters: [
                  [“StageName”, [“5 - Closed-Won”]]
                  [“Products”, “{{ results(step_top5_products) }}”]
            ]
            measures: [ [“sum”, “Amount”] ]
```

If a step is constrained by a particular set of filters, filter binding can be used to constrain another step by the same filter values, according to some other implementations. In one implementation, filter binding is applied on steps that reference different EdgeMarts. The following step is constrained by a CloseDate Year of 2014, according to the following code:

step_owner_by_role:

type: “aggregate”
em: “opp”
query:

groups: [“Owner-UserRole-Name”, “CloseDate Year”]
filters: [

[“CloseDate Year”, [“2014”]]

]
measures: [ [“sum”, “Amount”] ]

To constrain subsequent steps by the same filter dimension and values, the appropriate dimension, step, and dimension name can be referenced within filters as follows:

step_quota_filtered_by_role:

type: “aggregate”
em: “quota”
query:

filters: [

[“Closed Year”, “{{ filter(step_opp_owner_role,
‘CloseDate Year’) }}”]

In one implementation, bindings are calculated for all the steps using the following code:

```
_computeBindings: ->
      for name, step of @_stepsByName
            if step.multiBindings
                  bindings = @_inferBindings step, @_stepNames,
                  @ctx.ns step.multiBindings.bind bindings
```

In another implementation, if a binding originates from a step that accumulates event parameters, then previously fired bound events are injected into the multi-binding as follows:

for eventName of bindings

eventParts = eclair.utils.getEventParts eventName
bindingStep =

if eventParts.name is ‘runtime’
@
else

@_stepsByName[eventParts.name]

In yet another implementation, a “RuntimeEventDispatcher” saves event parameters, which reinject the value into the step as follows:

if bindingStep instanceof RuntimeEventDispatcher

value = bindingStep.argsForEvent eventParts.type
value = value[0] if _.isArray value
step.multiBindings.params[eventParts.name + “:” +
eventParts.type] = value

Given a step and hashmap of stepNames, the necessary bindings are inferred and the hashmap are returned using the following code:

```
_inferBindings: (step, stepNames, ns) ->
        # dry run to get the input types
        bindingsArray = [“runtime:start”]
        if step.query
            bindingCtx =
                results: (step) -> bindingsArray.push
                “#{step}:#{RuntimeEngine.STEP_EVENT_RESULTS}”
                filter: (step) -> bindingsArray.push
                “#{step}:#{RuntimeEngine.STEP_EVENT_BINDINGS_DONE}”
                selection: (step) -> bindingsArray.push
                “#{step}:#{RuntimeEngine.STEP_EVENT_SELECTION}”
                facet_selection: (step) -> bindingsArray.push
                “#{step}:#{RuntimeEngine.STEP_EVENT_SELECTION}”
                value: -> # this doesn't affect the bindings
                single_quote: -> # this doesn't affect the bindings
                sum: (step) -> bindingsArray.push
                “#{step}:#{RuntimeEngine.STEP_EVENT_RESULTS}”
                min: (step) -> bindingsArray.push
                “#{step}:#{RuntimeEngine.STEP_EVENT_RESULTS}”
                max: (step) -> bindingsArray.push
                “#{step}:#{RuntimeEngine.STEP_EVENT_RESULTS}”
            bindingCtx = Klass.extend(bindingCtx, stepNames)
```

At run time, a step is determined for a particular widget based on the corresponding binding configuration. In one implementation, this is achieved by using the following code:

```
# get step used for widget
step =
    if params.step then @_getStep params.step
    else null
if step
    params.selectMode = step.selectMode
```

Once the step is determined, the corresponding widget is loaded into the dashboard using the following switch statement, according to one implementation:

widget =

switch type

when “NumberWidget” then new
runtime.widgets.NumberWidget args
when “ValuesTable” then new runtime.widgets.ValuesTable
args
when “CompareTable” then new runtime.widgets.CompareTable
args
when “ChartWidget” then new runtime.widgets.ChartWidget
args
when “PillBox” then new runtime.widgets.PillBox args
when “BoxWidget” then new runtime.widgets.BoxWidget args
when “TextWidget” then new runtime.widgets.TextWidget args
when “ActionButton” then new runtime.widgets.ActionButton
args
when “ListSelector”, “RangeSelector”, “DateSelector”,
“GlobalFiltersWidget”, “LinkWidget”, “YoutubeWidget”

@renderReactComponent type, args, pos

when “Card”

cardName = params.card
cardTemplate = @_getCardTemplate cardName
new runtime.widgets.CardWidget {name, params,
cardTemplate, parentRuntime: @}

else

@_throwError(LC.getLabel “ErrorMsg”,
“invalidWidgetType”, type)

In other implementations, the visualization of the dashboard, such as assignment of colors to different dimension values; nesting of the results as groups with corresponding current coding; and visualization effects such as a “waterfall” effect representing transformation of one widget type to another can be achieved by using the following code:

# map of dim values which need to be colored (the key is the dim value,
the value is true)

colorDimValuesMap = { }

# nest the results using group, and optional color, dimensions

rowKeyFct = utils.keyFct(groups)
groups = utils.nest(results, [ rowKeyFct, utils.keyFct([ colorDim ]) ])

# waterfall effect

isWaterfall = @type is “waterfall”

### Morphine Example

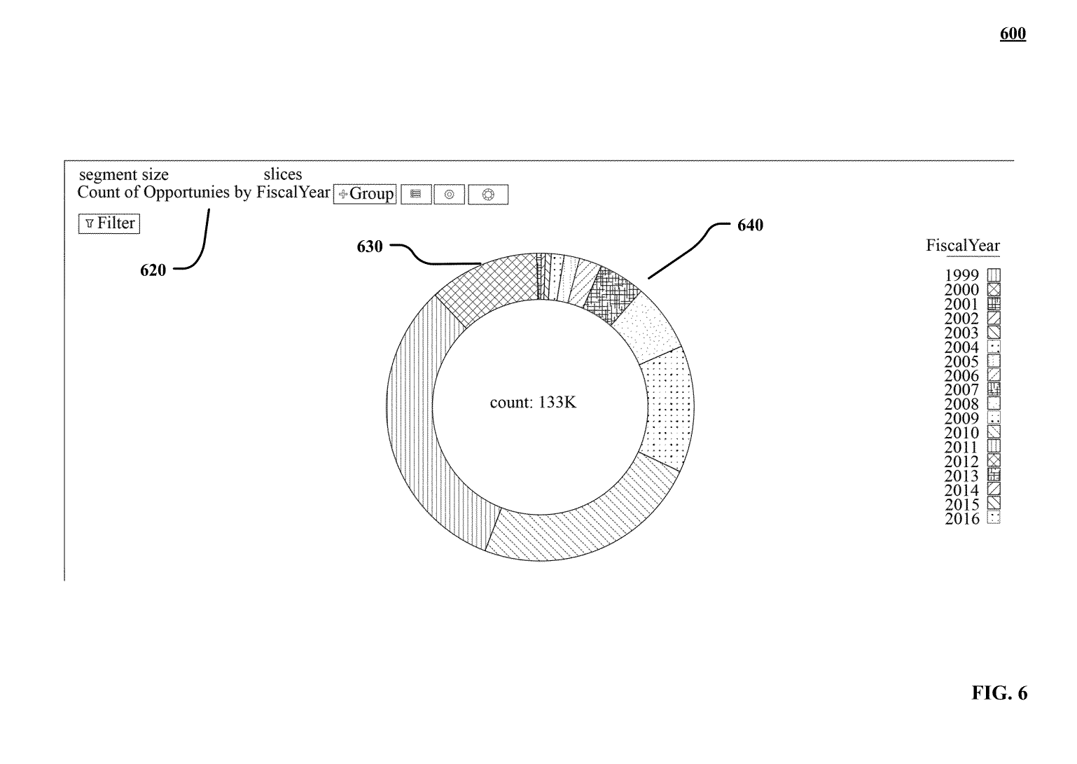

Analysis of data can include filtering, regrouping, and choosing and adding visualization lenses. FIG. 6 shows query results for a count of opportunities by fiscal year 620 for an example analytic data structure—an opportunity EdgeMart 150. In this context, an opportunity refers to an opportunity to win a sale, as shown in pie chart 640. Note that dates in the following examples extend to 2016 to cover dates when opportunities are expected to close.

### Regrouping Example: Pie Chart to Three Pie Charts

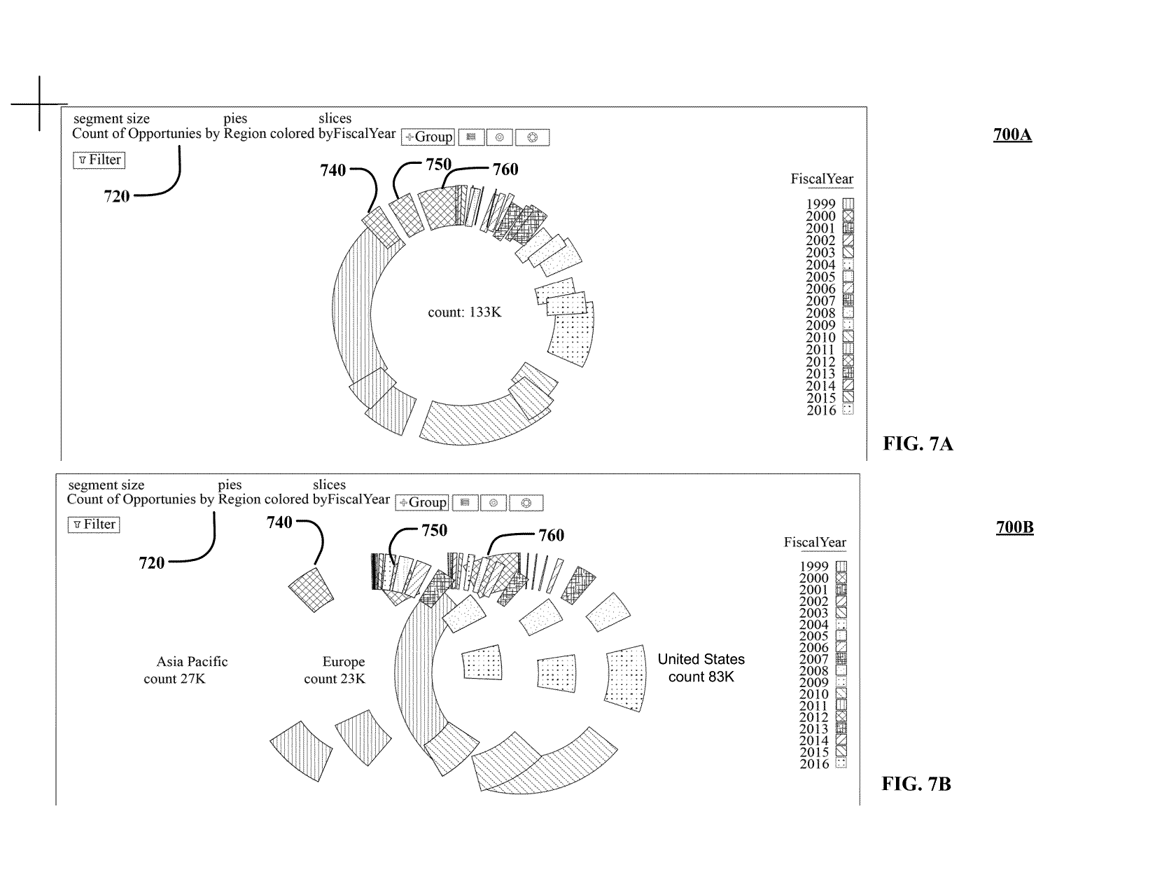

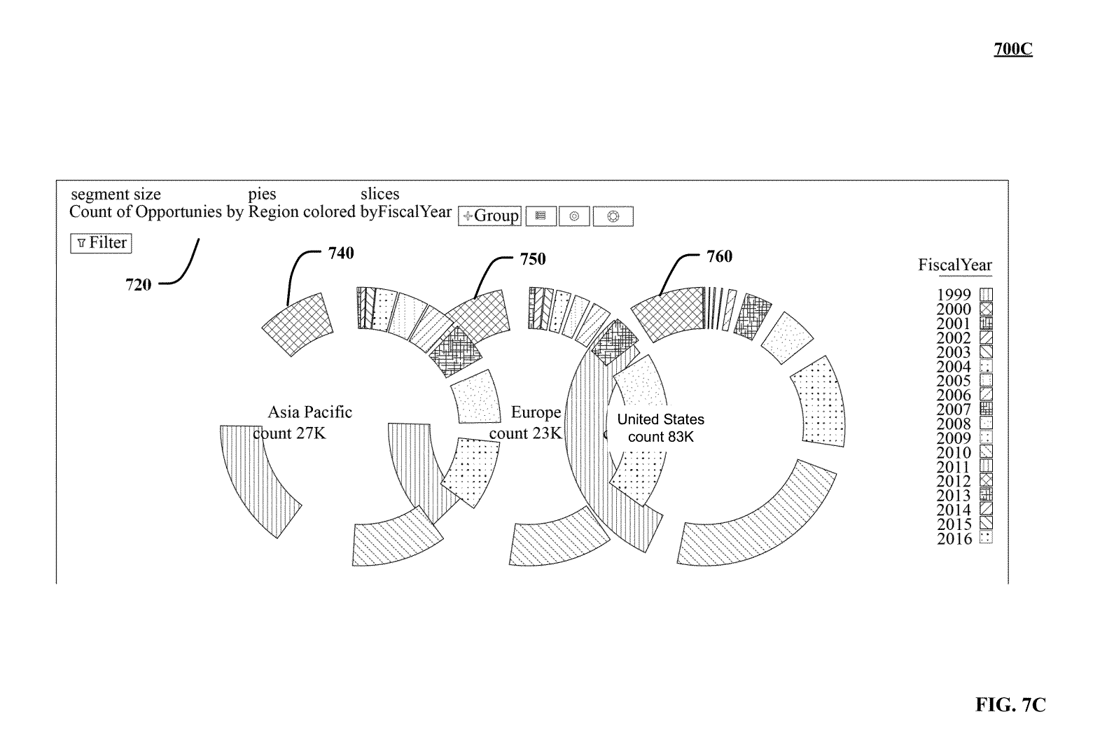

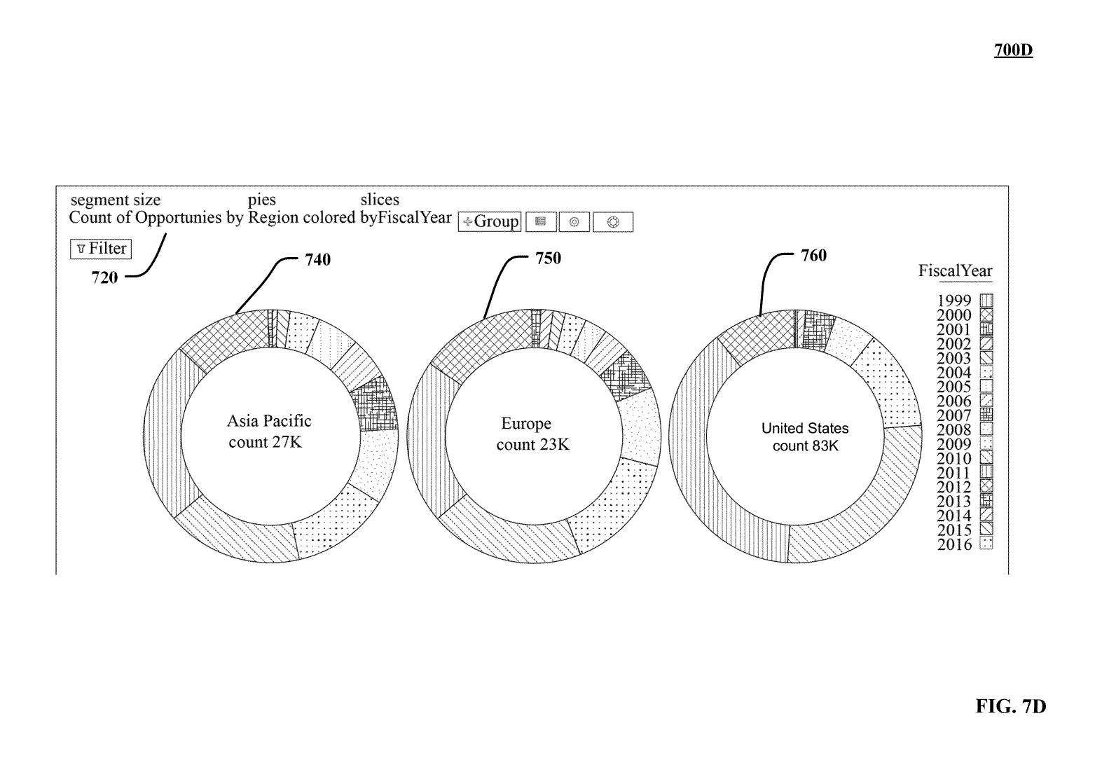

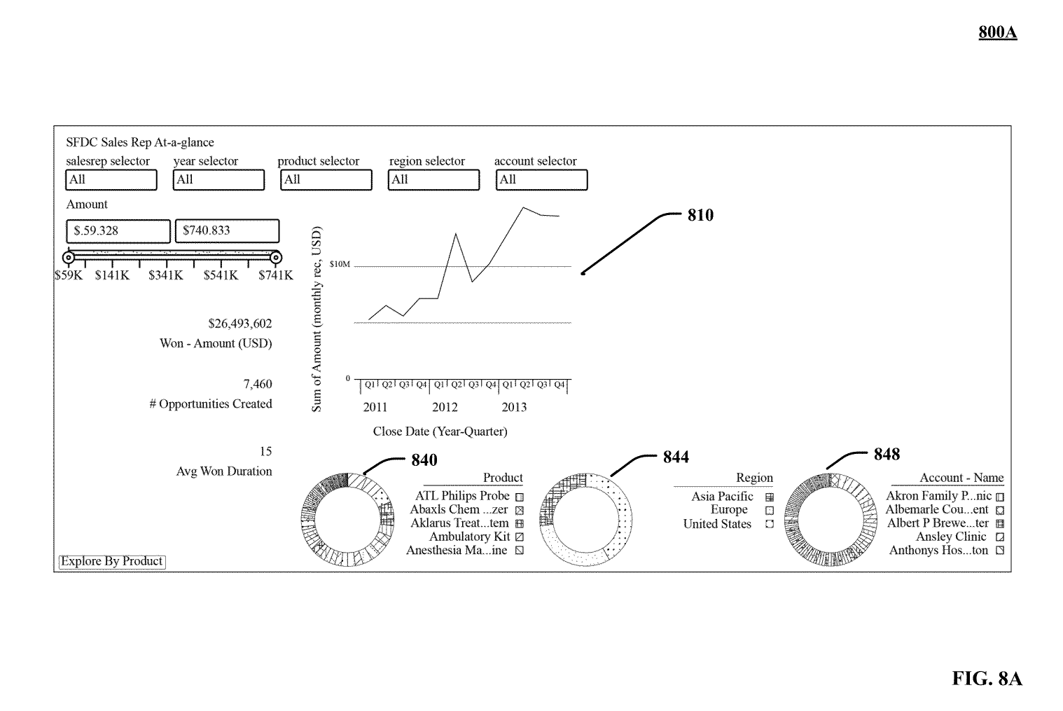

An analyst may regroup the view shown in pie chart 640 to view opportunities by region, as well as fiscal year. FIG. 7A shows the data from pie chart 640—as segments begin to regroup to show a count of opportunities by region, coded by fiscal year 620. An animated projection of segments morphs the display panel from a first appearance as a single pie chart of count opportunities for all regions displayed by fiscal year, to a second appearance that filters and regroups the count of opportunities for each of three regions.

FIG. 7A through FIG. 7D show transitional panels in an animation progression for segments of pie chart 640. For example, the analyst can follow the year 2012 opportunity data segment 630 as morphing progresses, as shown in FIG. 7B through FIG. 7D. As part of the animation progression, opportunity data segment 630 subdivides and regroups, morphing to segments for Asia Pacific 740, Europe 750 and United States 760—representing the opportunities for the year 2012 for each of the 3 respective regions. Similarly, the analyst can follow the animation progression for any of the fiscal years represented in the pie chart 640. In FIG. 7D we see opportunity counts for Asia Pacific 740, Europe 750 and the United States 760, with data counts coded by fiscal year in three separate pie charts.

Dashboard Animation

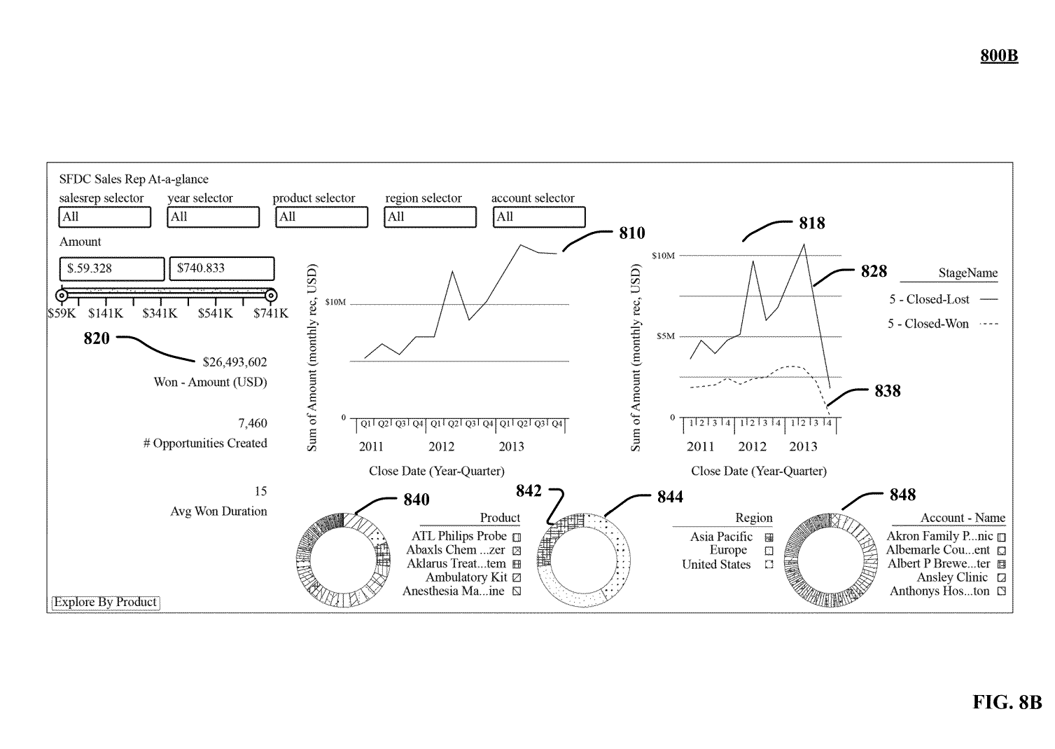

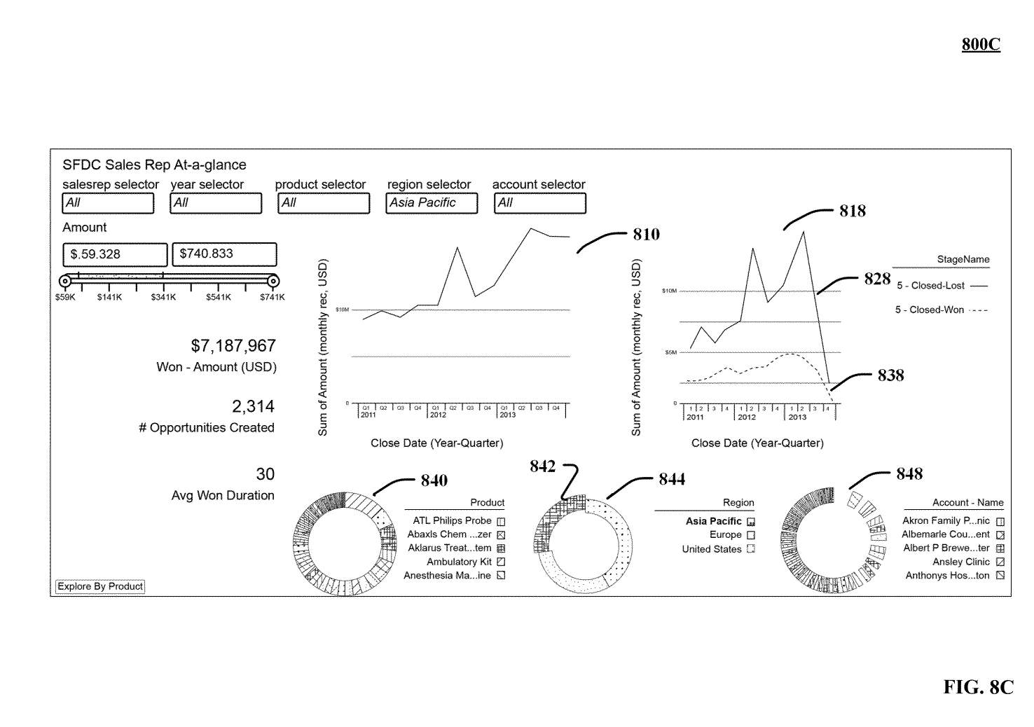

Analysts can use a live dashboard to review sales data. For example, FIG. 8A shows a sales rep at-a-glance dashboard that includes a graph of amount received in dollars by close date (year-quarter) 810 along with 3 pie charts that show the breakdown by product chart 840, region chart 844 and account name chart 848. To drill down and learn more, an analyst can add a visualization lens for sums won and sums lost as a function of the close date 818. FIG. 8B shows the sales rep at-a-glance dashboard with this new visualization lens for sums won and sums lost as a function of the close date 818 added—a plot of the amount received in dollars, filtered by opportunities lost 838 and opportunities won (sales) 828. The analyst benefits from seeing that the story being told is well represented in graphs of actual data, immediately upon adding the new graph panel to the dashboard. Mistakes in panel configuration and size issues with visualization are immediately apparent.

### Dashboard Widget and Query Step Examples

In a disclosed implementation of a dashboard shown in FIG. 8C, sales rep at-a-glance, steps and widgets describe visualization lenses. Examples of widget and step code for various widget types are included next. For example, code for the widget for the Won-Amount 820 display panel shown in FIG. 8C:

number_sum_amount:

```
type: “NumberWidget”
pos:
        x: 10
        y: 240
params:
        step: “step_selected_salesreps”
        title: “Won - Amount (USD)”
        measureField: “sum_Amount”
```

For some implementations of the Won-Amount 820 display panel shown in FIG. 8C, the step_selected_salesreps step is associated with the number widget described above. Example JSON code for the step_selected_salesreps step:

Closed - Won

step_selected_salesreps:

type: “aggregate”
em: “opp”
query:

filters: [

[“StageName”, [“5 - Closed-Won”]]

]
measures: [ [“sum”, “Amount”], [“avg”, “Open Duration”]
]

extra:

chartType: “hbar”

isFacet: true
useGlobal: true

As another widget and step example, a graph of sums won and sums lost as a function of the close date 818 can be implemented using JSON code for a list selector type widget:

```
sel_regions:
        type: “ListSelector”
        pos:
            x: 600
            y: 10
        params:
            expanded: false
            title: “region selector”
            step: “step_all_regions”
            instant: true
            multiSelect: false
            measureField: “sum_Amount”
```

Example JSON code for the closed-won step associated with the list selector widget for the visualization lens that renders sums won and sums lost as a function of the close date 818 is listed below.

# win loss

step_win_loss:

type: “aggregate”
em: “opp”
query:

groups: [[“CloseDate_Year”, “CloseDate_Quarter”],

“StageName”]

filters: [

[“StageName”, [“5 - Closed-Won”, “5 -
Closed-Lost”]]

]
measures: [ [“sum”, “Amount”] ]

extra:

chartType: “time”

isFacet: true
useGlobal: true

A region chart 844 can be implemented using the chart widget, pie_regions, shown below.

```
pie_regions:
      type: “ChartWidget”
      pos:
            x: 640
            y: 490
            w: 320
            h: 200
      params:
            step: “step_all_regions”
            chartType: “pie”
      legend: true
```

Example JSON code for selecting all regions of a graph, using a region query step for the chart widget:

```
# region selector
    step_all_regions:
        type: “aggregate”
        em: “opp”
        query:
            groups: [“Region”]
            measures: [ [“sum”, “Amount”] ]
            order: [ [−1, ascending: false] ]
        extra:
            chartType: “pie”
        selectMode: “single”
        isFacet: true
        useGlobal: true
```

Example code for a selector widget for selecting a region on the dashboard such as the Asia Pacific segment 842 of the region chart 844 is listed below.

sel_amount_expanded:

```
type: “RangeSelector”
pos:
        x: 10
        y: 70
params:
        title: “Amount”
        step: “step_all_amounts_expanded”
        instant: true
```

Example JSON code for the region selector step for selecting a region such as the Asia Pacific segment 842 of the region chart 844:

```
# amount selector
    step_all_amounts_expanded:
        type: “aggregate”
        em: “opp”
        query:
            measures: [ [“sum”, “Amount”] ]
        isFacet: true
        useGlobal: true
```

In example JSON code, a range selector widget can specify a change amount. For example, a sel_amount_expanded widget is attached to the amount selector step.

sel_amount_expanded:

type: “RangeSelector”
pos:

x: 10
y: 70

params:

title: “Amount”
step: “step_all_amounts_expanded”
instant: true

In the example JSON code, an amount selector query step works in conjunction with a range selector widget:

```
# amount selector
      step_all_amounts_expanded:
            type: “aggregate”
            em: “opp”
            query:
                  measures: [ [“sum”, “Amount”] ]
            isFacet: true
            useGlobal: true
```

### System Flow

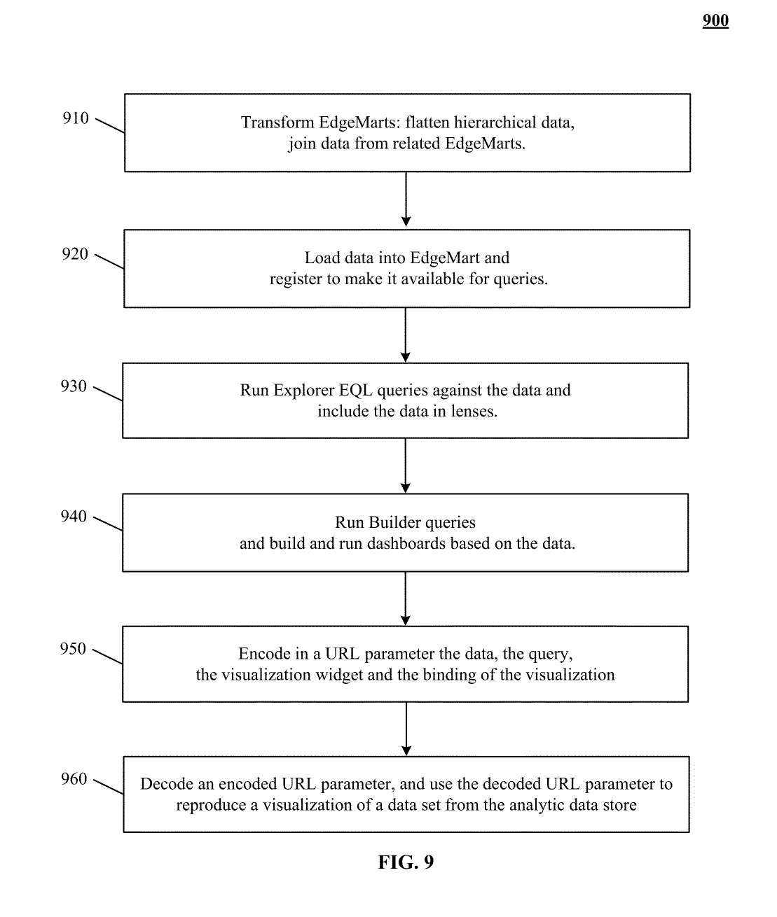

FIG. 9 shows an overview of the flow for implementing deep linking and state preservation via a URL, capturing and encoding state information for recreating animated informational morphing replays for live data on a live dashboard. For convenience, the method illustrated by this flow is discussed in the context of a system that implements the method, such as the system depicted in FIG. 1. The method does not depend on this particular system. It is a computerized method that can be implemented on many alternative hardware platforms. While the flow is depicted in particular steps, these step can be consolidated, subdivided, reordered or run in parallel while still taking advantage of the technology disclosed.

Back-end systems and methods transform EdgeMarts. For example, an ELT engine 160 flattens hierarchical data, joins data from related EdgeMarts, and increases query performance on specific data 910. The ELT engine 160 transforms the data and loads it into an EdgeMart data structure 150. The system registers the EdgeMart 920 and makes it available for queries.

From a front end perspective, a query engine 140 runs Explorer EQL queries against the EdgeMart data. The data results are rendered in lenses 930. Analyst-developers can use the explorer engine 110 or the live dashboard builder engine 115 to run or build and run dashboards based on the data 940. Analyst-developers rely on the URL engine 120 to encode in a URL parameter the data, the query, the visualization widget and the binding of the visualization 950—for transmitting to a recipient user computing device 165 for recreating a previously rendered lens. Recipients of an encoded URL rely on the URL engine 120 are decode the encoded URL parameter to reproduce a visualization of a data set from the analytic data store.

### Flow for Deep Linking and State Preservation Via a URL

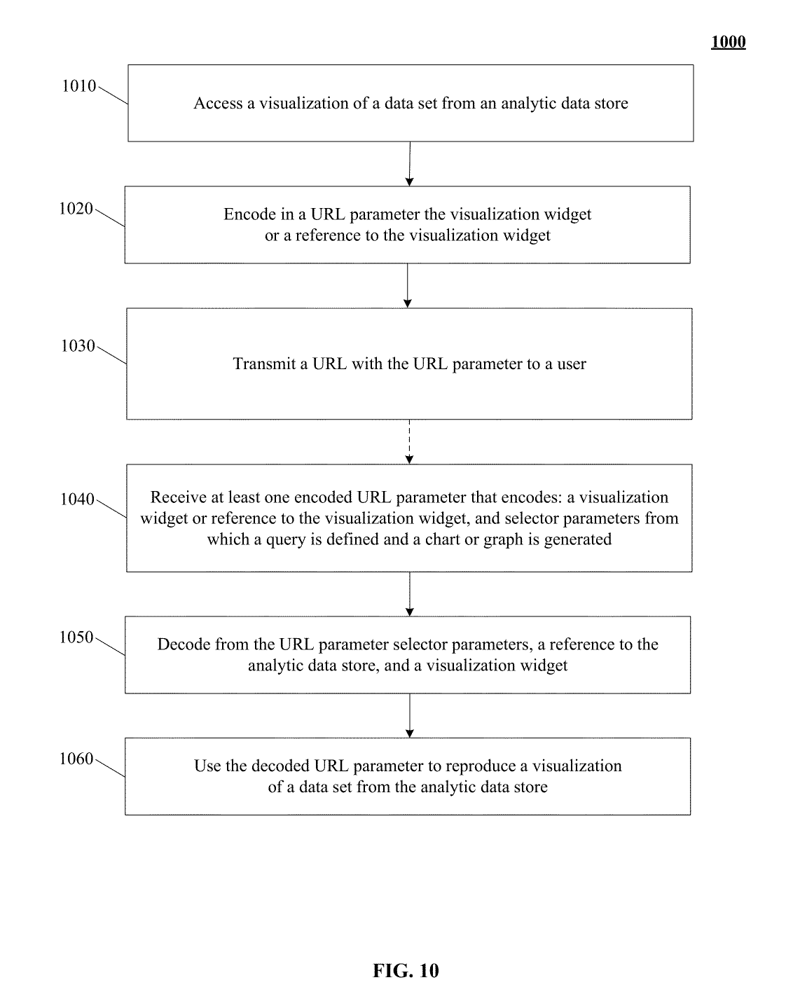

FIG. 10 illustrates a flowchart of one method 1000 of deep linking and state preservation via a URL. Flowchart 1000 can be implemented at least partially with a database system, e.g., by one or more processors configured to receive or retrieve information, process the information, store results, and transmit the results. For convenience, this flowchart is described with reference to the system that carries out a method. The system is not necessarily part of the method. Other implementations may perform the steps in different orders and/or with different, fewer or additional steps than the ones illustrated in FIG. 10. The actions described below can be subdivided into more steps or combined into fewer steps to carry out the method described using a different number or arrangement of steps.

At action 1010, a method includes accessing a visualization of a data set from an analytic data store, in which the data set is defined by a query against at least one analytic data store; the data set is bound by a binding to at least one visualization widget, and the visualization widget presents the data set in a chart or graph. At action 1020, the method includes encoding in a URL parameter the visualization widget or a reference to the visualization widget encoding the visualization widget or a reference to the visualization widget, wherein the visualization widget is bound to an analytic data store; and encoding selector parameters from which the query is defined and the chart or graph is generated. At action 1030 the method includes transmitting a URL with the URL parameter to a user. At action 1040, the method includes receiving at least one encoded URL parameter that encodes: a visualization widget or reference to the visualization widget, and selector parameters from which a query is defined and a chart or graph is generated.

At action 1050, the method includes decoding from the URL parameter selector parameters, a reference to the analytic data store, and a visualization widget. At action 1060, the method includes using the decoded URL parameter to reproduce a visualization of a data set from the analytic data store.

### Computer System

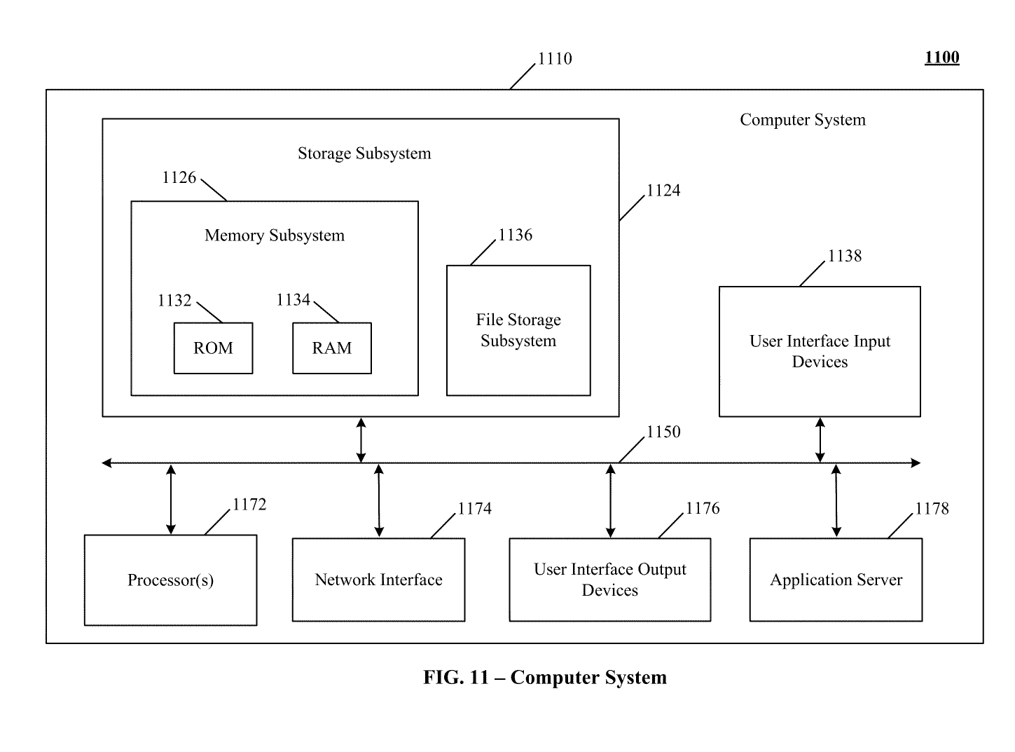

FIG. 11 is a block diagram of an example computer system 1200 with an apparatus and methods for deep linking and state preservation via a URL. Computer system 1110 typically includes at least one processor 1172 that communicates with a number of peripheral devices via bus subsystem 1150. These peripheral devices can include a storage subsystem 1126 including, for example, memory devices and a file storage subsystem 1136, user interface input devices 1138, user interface output devices 1176, and a network interface subsystem 1146. The input and output devices allow user interaction with computer system 1110. Network interface subsystem 1174 provides an interface to outside networks, including an interface to corresponding interface devices in other computer systems.

User interface input devices 1176 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include possible types of devices and ways to input information into computer system 1110.

User interface output devices 1176 can include a display subsystem, a printer, a fax machine, or non-visual displays such as audio output devices. The display subsystem can include a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1110 to the user or to another machine or computer system.

Storage subsystem 1124 stores programming and data constructs that provide the functionality of some or all of the modules and methods described herein. These software modules are generally executed by one processor 1172 or in combination with other processors.

Memory 1126 used in the storage subsystem can include a number of memories including a main random access memory (RAM) 1134 for storage of instructions and data during program execution and a read only memory (ROM) 1132 in which fixed instructions are stored. A file storage subsystem 1136 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1136 in the storage subsystem 1124, or in other machines accessible by the processor.

Bus subsystem 1150 provides a mechanism for letting the various components and subsystems of computer system 1110 communicate as intended. Although bus subsystem 1150 is shown schematically as a single bus, alternative implementations of the bus subsystem can use multiple busses. Application server 1178 can be a framework that allows the applications of computer system 1110 to run, such as the hardware and/or software, e.g., the operating system.

Computer system 1110 can be of varying types including a workstation, server, computing cluster, blade server, server farm, or any other data processing system or computing device. Due to the ever-changing nature of computers and networks, the description of computer system 1110 depicted in FIG. 11 is intended only as one example. Many other configurations of computer system 1110 are possible having more or fewer components than the computer system depicted in FIG. 11.

In some implementations, network(s) can be any one or any combination of Local Area Network (LAN), Wide Area Network (WAN), WiMAX, Wi-Fi, telephone network, wireless network, point-to-point network, star network, token ring network, hub network, mesh network, peer-to-peer connections like Bluetooth, Near Field Communication (NFC), Z-Wave, ZigBee, or other appropriate configuration of data networks, including the Internet.

### Particular Implementations

In one implementation, a method is described of sharing a state of a database search result and visualization. The method includes accessing a visualization of a data set from an analytic data store wherein the data set is defined by a query against at least one analytic data store. The data set is bound by a binding to at least one visualization widget, and the visualization widget presents the data set in a chart or graph. The method further includes encoding in at least one URL parameter the visualization widget or a reference to the visualization widget, wherein the visualization widget is bound to an analytic data store; and selector parameters from which the query is defined and the chart or graph is generated. The method also includes transmitting a URL with the encoded URL parameter to a user.

This method and other implementations of the technology disclosed can include one or more of the following features and/or features described in connection with additional methods disclosed. In the interest of conciseness, the combinations of features disclosed in this application are not individually enumerated and are not repeated with each base set of features. The reader will understand how features identified in this section can readily be combined with sets of base features identified for sharing a state of a database search result and visualization.

In one implementation, the visualization of the data set includes multiple panels, in which each panel declares a chart or table data visualization into which an associated data set returned by an associated query will be rendered by an associated visualization widget. For this method, at least some of the panels set a facet property, wherein the facet property links operation of data filtering controls among the panels, wherein selection of a data filter control in one panel causes the selected data filter control to be applied to additional panels that have the facet property set. The method further includes encoding in the URL parameter, state information that defines the panels and the facet property of the panels.

In one implementation, the visualization widgets include control widgets. For this method, each control widget is declared to have a control widget type selected from a group that includes at least list selector, range selector and date selector types; and each control widget selects a value or range of values of at least one associated dimension that is used to generate a query; and further includes encoding in the URL parameter, state information that represents selections made with the control widgets.

In one implementation, a method is described of recreating a state of a database search result and visualization from an encoded URL. This method includes receiving at least one URL parameter that encodes: a visualization widget or a reference to the visualization widget, wherein the visualization widget is bound to an analytic data store; and selector parameters from which a query is defined and a chart or graph is generated. The method further includes decoding from the URL parameter: decoded selector parameters, a decoded reference to the analytic data store, and a decoded visualization widget. The method also includes using the decoded URL parameter to reproduce a visualization of a data set from the analytic data store, wherein the decoded selector parameters define the query that produces a data set from the analytic data store; the data set is bound by a binding to the decoded visualization widget; and the decoded visualization widget transforms the data set into a chart or graph visualization.

The method described includes the visualization of the data set includes multiple panels; and decoding from the URL parameter, state information that defines the panels and a facet property of the panels; wherein each panel declares a chart or table data visualization into which an associated data set returned by an associated query will be rendered by an associated visualization widget. For this method, at least some of the panels set the facet property, wherein the facet property links operation of data filtering controls among the panels, wherein selection of a data filter control in one panel causes the selected data filter control to be applied to additional panels that have the facet property set. This method further uses the decoded URL parameter to reproduce a visualization of a data set from the panels and the facet property of the panels.

In the method described, the visualization widgets include one or more control widgets. This method includes decoding, from the URL parameter, state information that represents selections made with the control widgets. Each control widget is declared to have a control widget type selected from a group that includes at least list selector, range selector and date selector types; and each control widget selects a value or range of values of at least one associated dimension that is used to generate the query.

In one implementation, an apparatus is described for sharing a state of a database search result and visualization. The apparatus comprises a computer that includes a processor and a memory coupled to the processor. In addition, the memory includes computer program instructions causing the computer to implement a process. The process includes accessing a visualization of a data set from an analytic data store wherein the data set is defined by a query against at least one analytic data store. The data set is bound by a binding to at least one visualization widget; and the visualization widget presents the data set in a chart or graph. The process includes encoding in at least one URL parameter: the visualization widget or a reference to the visualization widget, wherein the visualization widget is bound to an analytic data store; and selector parameters from which the query is defined and the chart or graph is generated. The process also includes transmitting a URL with the encoded URL parameter to a user. The process further includes receiving the URL parameter, decoding selector parameters, a reference to the analytic data store and a visualization widget; and using the decoded URL parameter to reproduce a visualization of a data set from the analytic data store.

Other implementations may include a tangible non-transitory computer readable storage medium storing instructions executable by a processor to perform any of the processes described above. Yet another implementation may include a system including memory and one or more processors operable to execute instructions, stored in the memory, to perform any of the processes described above.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. A method of sharing a state of a database search result and visualization, including:
accessing a visualization of a data set from an analytic data store wherein:
the data set is defined by a query against at least one analytic data store;
the data set is bound by a binding to at least one visualization widget; and
the visualization widget presents the data set in a chart or graph;
encoding in at least one URL parameter, including:
encoding the visualization widget or a reference to the visualization widget, wherein the visualization widget is bound to an analytic data store; and
encoding selector parameters from which the query is defined and the chart or graph is generated; and
transmitting a URL with the encoded URL parameter to a user.

2. A method of recreating a state of a database search result and visualization from an encoded URL, including:
receiving at least one URL parameter that encodes:
a visualization widget or a reference to the visualization widget, wherein the visualization widget is bound to an analytic data store; and
selector parameters from which a query is defined and a chart or graph is generated;
decoding from the URL parameter: decoded selector parameters, a decoded reference to the analytic data store, and a decoded visualization widget; and
using the decoded URL parameter to reproduce a visualization of a data set from the analytic data store, wherein:
the decoded selector parameters define the query that produces a data set from the analytic data store;
the data set is bound by a binding to the decoded visualization widget; and
the decoded visualization widget transforms the data set into a chart or graph visualization.

3. The method of claim 1, wherein:
the visualization of the data set includes multiple panels;
each panel declares a chart or table data visualization into which an associated data set returned by an associated query will be rendered by an associated visualization widget; and
at least some of the panels set a facet property, wherein the facet property links operation of data filtering controls among the panels, wherein selection of a data filter control in one panel causes the selected data filter control to be applied to additional panels that have the facet property set; and
further including encoding in the URL parameter, state information that defines the panels and the facet property of the panels.

4. The method of claim 1, wherein:
the visualization widgets include control widgets;
each control widget is declared to have a control widget type selected from a group that includes at least list selector, range selector and date selector types;
each control widget selects a value or range of values of at least one associated dimension that is used to generate a query; and
further including encoding in the URL parameter, state information that represents selections made with the control widgets.

5. The method of claim 2, wherein:
the visualization of the data set includes multiple panels;
further including decoding from the URL parameter, state information that defines the panels and a facet property of the panels; wherein:
each panel declares a chart or table data visualization into which an associated data set returned by an associated query will be rendered by an associated visualization widget;
at least some of the panels set the facet property, wherein the facet property links operation of data filtering controls among the panels, wherein selection of a data filter control in one panel causes the selected data filter control to be applied to additional panels that have the facet property set; and
using the decoded URL parameter to reproduce the visualization with the panels and the facet property of the panels.

6. The method of claim 2, wherein:
the visualization widgets include one or more control widgets;
further including decoding from the URL parameter, state information that represents selections made with the control widgets, wherein:
each control widget is declared to have a control widget type selected from a group that includes at least list selector, range selector and date selector types; and
each control widget selects a value or range of values of at least one associated dimension that is used to generate the query.

7. An apparatus for analyzing data and conveying analysis results comprising:
a computer including a processor;
a memory coupled to the processor, wherein the memory includes computer program instructions causing the computer to implement a process including:
accessing a visualization of a data set from an analytic data store wherein:
the data set is defined by a query against at least one analytic data store;
the data set is bound by a binding to at least one visualization widget; and
the visualization widget presents the data set in a chart or graph; and
encoding in at least one URL parameter, including:
encoding the visualization widget or a reference to the visualization widget, wherein the visualization widget is bound to an analytic data store; and
encoding selector parameters from which the query is defined and the chart or graph is generated; and
transmitting a URL with the encoded URL parameter to a user.

8. A system including the apparatus of claim 7 and further including:
a second computer including a second processor;
a memory coupled to the second processor, wherein the memory includes computer program instructions causing the second computer to implement a process including:
receiving the URL parameter;
decoding from the URL parameter: decoded selector parameters, a decoded reference to the analytic data store and a decoded visualization widget; and
using the decoded URL parameter to reproduce a visualization of a data set from the analytic data store.

9. The apparatus of claim 7, further including computer program instructions causing the computer to implement a process wherein:
the visualization of the data set includes multiple panels;
each panel declares a chart or table data visualization into which an associated data set returned by an associated query will be rendered by an associated visualization widget;
at least some of the panels set a facet property, wherein the facet property links operation of data filtering controls among the panels, wherein selection of a data filter control in one panel causes the selected data filter control to be applied to additional panels that have the facet property set; and
further including encoding in the URL parameter, state information that defines the panels and the facet property of the panels.

10. The apparatus of claim 7, further including computer program instructions causing the computer to implement a process wherein:
the visualization of the data set includes control widgets;
each control widget is declared to have a control widget type selected from a group that includes at least list selector, range selector and date selector types;
each control widget selects a value or range of values of at least one associated dimension that is used to generate a query; and
further including encoding in the URL parameter, state information that represents selections made with the control widgets.

11. The apparatus of claim 8, further including computer program instructions causing the computer to implement a process wherein:
the visualization of the data set includes multiple panels;
decodes from the URL parameter, state information that defines the panels and a facet property of the panels; wherein:
each panel declares a chart or table data visualization into which an associated data set returned by an associated query will be rendered by an associated visualization widget;
at least some of the panels set a facet property, wherein the facet property links operation of data filtering controls among the panels, wherein selection of a data filter control in one panel causes the selected data filter control to be applied to additional panels that have the facet property set; and
uses the decoded URL parameter to reproduce the visualization of the data set from the panels and the facet property of the panels.

12. The apparatus of claim 8, further including computer program instructions causing the computer to implement a process wherein:
the visualization widgets include one or more control widgets;
further including decoding from the URL parameter, state information that represents selections made with the control widgets, wherein:
each control widget is declared to have a control widget type selected from a group that includes at least list selector, range selector and date selector types; and
each control widget selects a value or range of values of at least one associated dimension that is used to generate the query.

13. A non-transitory computer-readable memory including computer program instructions that cause a computer system to:
access a visualization of a data set from an analytic data store wherein:
the data set is defined by a query against at least one analytic data store;
the data set is bound by a binding to at least one visualization widget; and
the visualization widget presents the data set in a chart or graph; and
encode in at least one URL parameter, to:
encode the visualization widget or a reference to the visualization widget, wherein the visualization widget is bound to an analytic data store; and
encode selector parameters from which the query is defined and the chart or graph is generated; and
transmit a URL with the encoded URL parameter to a user.

14. A non-transitory computer-readable memory of claim 13, further including computer program instructions that cause a computer system to:
receive at least one URL parameter that encodes:
a visualization widget or a reference to the visualization widget, wherein the visualization widget is bound to an analytic data store; and
selector parameters from which a query is defined and the chart or graph is generated;
decode from the URL parameter: decoded selector parameters, a decoded reference to the analytic data store, and a decoded visualization widget; and
use the decoded URL parameter to reproduce the visualization of the data set from the analytic data store, wherein:
the decoded selector parameters define the query that produces the data set from the analytic data store;
the data set is bound by a binding to the decoded visualization widget; and
the decoded visualization widget transforms the data set into a chart or graph visualization.

15. The non-transitory computer-readable memory of claim 13, wherein:
the visualization of the data set includes multiple panels;
each panel declares a chart or table data visualization into which an associated data set returned by an associated query will be rendered by an associated visualization widget;
at least some of the panels set a facet property, wherein the facet property links operation of data filtering controls among the panels, wherein selection of a data filter control in one panel causes the selected data filter control to be applied to additional panels that have the facet property set; and
further including computer program instructions that cause a computer system to encode in the URL parameter, state information that defines the panels and the facet property of the panels.

16. The non-transitory computer-readable memory of claim 13, wherein:
the visualization widgets include control widgets;
each control widget is declared to have a control widget type selected from a group that includes at least list selector, range selector and date selector types;
each control widget selects a value or range of values of at least one associated dimension that is used to generate a query; and
further including encoding in the URL parameter, state information that represents selections made with the control widgets.

17. The non-transitory computer-readable memory of claim 14 wherein:
the visualization of the data set includes multiple panels;
each panel declares a chart or table data visualization into which an associated data set returned by an associated query will be rendered by an associated visualization widget; and
at least some of the panels set a facet property, wherein the facet property links operation of data filtering controls among the panels, wherein selection of a data filter control in one panel causes the selected data filter control to be applied to additional panels that have the facet property set; and
further including computer program instructions that cause a computer system to decode from the URL parameter, state information that defines the panels and a facet property of the panels; and
use the decoded URL parameter to reproduce the visualization of the data set from the panels and the facet property of the panels.

18. The non-transitory computer-readable memory of claim 14, wherein:
the visualization widgets include one or more control widgets;
further including computer program instructions that cause a computer system to decode from the URL parameter, state information that represents selections made with the control widgets, wherein:
each control widget is declared to have a control widget type selected from a group that includes at least list selector, range selector and date selector types; and
each control widget selects a value or range of values of at least one associated dimension that is used to generate the query.
